(19) United States
(12) Patent Application Publication
(10) Pub. No.: US 2026/0040357 A1
(43) Pub. Date: Feb. 5, 2026

(54) SBFD-AWARE UE CONFIGURATION IN CASE OF RACH OCCASION ACROSS SBFD SYMBOLS AND NON-SBFD SYMBOLS

(71) Applicant: QUALCOMM Incorporated, San Diego, CA (US)

(72) Inventors: Mohammed JABI, San Diego, CA (US); Muhammad Sayed Khairy ABDELGHAFFAR, San Jose, CA (US); Prashant SHARMA, San Marcos, CA (US); Jae Ho RYU, San Diego, CA (US)

(21) Appl. No.: 18/793,691

(22) Filed: Aug. 2, 2024

(51) Int. Cl. H04W 74/0833; H04L 5/14

(52) U.S. Cl. CPC H04W 74/0833; H04L 5/14

(57) ABSTRACT

Methods and apparatuses are provided for managing transitions between sub-band frequency division duplex (SBFD) and non-SBFD modes in full duplex communication systems. A RACH occasion is configured spanning across a SBFD symbol, a subsequent non-SBFD symbol, and a period between the symbols for transitioning between SBFD communications and non-SBFD communications. A wireless device may determine whether a UE is to switch from a first uplink configuration associated with SBFD communications to a second uplink configuration associated with non-SBFD communications during a configuration transition period. The device may communicate a RACH preamble before, during, or after the switch. A timing of the configuration transition period may be based on scheduling restrictions, reported UE capabilities, determined guard symbol lengths, or configured SBFD or non-SBFD modes for RACH occasions. Thus, uninterrupted PRACH transmission across SBFD and non-SBFD symbols may be achieved, enhancing the efficiency of data communication in full duplex systems.

### TECHNICAL FIELD

The present disclosure generally pertains to the field of wireless communication, and more particularly, to the configuration and operation of sub-band frequency division duplex (SBFD)-aware user equipment (UE) in scenarios where a random access channel (RACH) occasion spans across SBFD symbols and non-SBFD symbols.

### DESCRIPTION OF THE RELATED TECHNOLOGY

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IOT)), and other requirements. 5G NR includes services associated with enhanced mobile broadband (cMBB), massive machine type communications (mMTC), and ultra-reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### SUMMARY

The following presents a simplified summary of one or more aspects in order to provide a basic understanding of such aspects. This summary is not an extensive overview of all contemplated aspects and is intended to neither identify key or critical elements of all aspects nor delineate the scope of any or all aspects. Its sole purpose is to present some concepts of one or more aspects in a simplified form as a prelude to the more detailed description that is presented later.

One innovative aspect of the subject matter described in this disclosure may be implemented in an apparatus for wireless communication, which may be a user equipment (UE) or a network entity such as a base station. The apparatus includes one or more memories, and one or more processors each communicatively coupled with at least one of the one or more memories. The one or more processors, individually or in any combination, are operable to cause the apparatus to receive or transmit a configuration of a random access channel (RACH) occasion spanning across: at least a portion of a sub-band frequency division duplex (SBFD) symbol, at least a portion of a subsequent non-SBFD symbol in a same slot as or a different slot than the SBFD symbol, and a transition period between the SBFD symbol and the subsequent non-SBFD symbol. The transition period is for transitioning between SBFD communications and non-SBFD communications without interruption of a RACH preamble transmission. The one or more processors, individually or in any combination, are also operable to cause the apparatus to transmit or receive, in the RACH occasion, a RACH preamble in the SBFD symbol and the subsequent non-SBFD symbol before, during, or after a user equipment (UE) switch or a refrained UE switch from a first uplink configuration associated with the SBFD communications to a second uplink configuration associated with the non-SBFD communications during a configuration transition period. The configuration transition period includes one of: a first time period prior to a beginning of the RACH occasion in the SBFD symbol, a second time period following an end of the RACH occasion in the subsequent non-SBFD symbol, or a third time period within the transition period between the SBFD symbol and the subsequent non-SBFD symbol.

Another innovative aspect of the subject matter described in this disclosure may be implemented in a method for wireless communication performable at a wireless device, which may be a UE or a network entity such as a base station. The method includes receiving or transmitting a configuration of a RACH occasion spanning across: at least a portion of a SBFD symbol, at least a portion of a subsequent non-SBFD symbol in a same slot as or a different slot than the SBFD symbol, and a transition period between the SBFD symbol and the subsequent non-SBFD symbol. The transition period is for transitioning between SBFD communications and non-SBFD communications without interruption of a RACH preamble transmission. The method further includes transmitting or receiving, in the RACH occasion, a RACH preamble in the SBFD symbol and the subsequent non-SBFD symbol before, during, or after a UE switch or a refrained UE switch from a first uplink configuration associated with the SBFD communications to a second uplink configuration associated with the non-SBFD communications during a configuration transition period. The configuration transition period includes one of: a first time period prior to a beginning of the RACH occasion in the SBFD symbol, a second time period following an end of the RACH occasion in the subsequent non-SBFD symbol, or a third time period within the transition period between the SBFD symbol and the subsequent non-SBFD symbol.

Another innovative aspect of the subject matter described in this disclosure may be implemented in an apparatus for wireless communication, which may be a UE or a network entity such as a base station. The apparatus includes means for receiving or transmitting a configuration of a RACH occasion spanning across: at least a portion of a SBFD symbol, at least a portion of a subsequent non-SBFD symbol in a same slot as or a different slot than the SBFD symbol, and a transition period between the SBFD symbol and the subsequent non-SBFD symbol. The transition period is for transitioning between SBFD communications and non-SBFD communications without interruption of a RACH preamble transmission. The means for receiving or transmitting is further configured to transmit or receive, in the RACH occasion, a RACH preamble in the SBFD symbol and the subsequent non-SBFD symbol before, during, or after a UE switch or a refrained UE switch from a first uplink configuration associated with the SBFD communications to a second uplink configuration associated with the non-SBFD communications during a configuration transition period. The configuration transition period includes one of: a first time period prior to a beginning of the RACH occasion in the SBFD symbol, a second time period following an end of the RACH occasion in the subsequent non-SBFD symbol, or a third time period within the transition period between the SBFD symbol and the subsequent non-SBFD symbol.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

FIG. 1A is a diagram illustrating an example of a wireless communications system and an access network.

FIG. 1B shows a diagram illustrating an example disaggregated base station architecture.

FIG. 2A is a diagram illustrating an example of a first subframe within a 5G NR frame structure.

FIG. 2B is a diagram illustrating an example of DL channels within a 5G NR subframe.

FIG. 2C is a diagram illustrating an example of a second subframe within a 5G NR frame structure.

FIG. 2D is a diagram illustrating an example of UL channels within a 5G NR subframe.

FIG. 3 is a block diagram illustrating an example of a base station and a UE involved in wireless communication.

FIGS. 4A-4C are diagrams illustrating examples of full-duplex communication including in-band full duplex (IBFD) and sub-band frequency division duplex (SBFD).

FIGS. 5A-5C are diagrams illustrating different examples of full duplex scenarios including IBFD and SBFD.

FIG. 6 is a diagram illustrating an example of a configured RACH occasion (RO) spanning across SBFD symbols and non-SBFD symbols, also referred to as a special RO.

FIG. 7 is a diagram illustrating an example of a first aspect of the present disclosure providing SBFD-aware UE behavior in special ROs between SBFD symbols and non-SBFD symbols.

FIG. 8 is a diagram illustrating an example of a sub-aspect of the first aspect of the present disclosure providing one or more validity rules for special ROs between SBFD symbols and non-SBFD symbols.

FIG. 9 is a diagram illustrating an example of a second aspect of the present disclosure providing SBFD-aware UE behavior in special ROs between SBFD symbols and non-SBFD symbols.

FIG. 10 is a diagram illustrating an example of a third aspect of the present disclosure providing SBFD-aware UE behavior in special ROs 602 between SBFD symbols and non-SBFD symbols.

FIGS. 11A-11D are diagrams illustrating various examples of additional aspects of the present disclosure providing scheduling restrictions, UE capabilities, guard symbol lengths, and configurations associated with special ROs spanning across SBFD symbols and non-SBFD symbols.

FIG. 12 is a diagram illustrating an example of a call flow between a base station and a UE.

FIGS. 13A-13B is a flowchart of an example method of wireless communication performable at a wireless device.

FIG. 14 is a diagram illustrating an example of a hardware implementation for an apparatus or wireless device that is a UE or a network entity such as a base station.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

Several aspects of telecommunication systems will now be presented with reference to various apparatus and methods. These apparatus and methods will be described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise.

Accordingly, in one or more example embodiments, the functions described may be implemented in hardware, software, or any combination thereof. If implemented in software, the functions may be stored on or encoded as one or more instructions or code on a computer-readable medium. Computer-readable media includes computer storage media. Storage media may be any available media that may be accessed by a computer. By way of example, and not limitation, such computer-readable media may comprise a random-access memory (RAM), a read-only memory (ROM), an electrically erasable programmable ROM (EEPROM), optical disk storage, magnetic disk storage, other magnetic storage devices, combinations of the aforementioned types of computer-readable media, or any other medium that may be used to store computer executable code in the form of instructions or data structures that may be accessed by a computer.

The present disclosure relates to wireless communication systems, particularly full duplex communication systems that allow for simultaneous transmission and reception of data. In these systems, there are two primary methods of achieving full duplex communication: in-band full duplex (IBFD) and sub-band frequency division duplexing (SBFD). However, a challenge arises when a random access channel (RACH) occasion spans across SBFD symbols and non-SBFD symbols, as this begs the question of how a user equipment (UE) may manage transitions between SBFD and non-SBFD modes without interrupting transmission of RACH preambles across the symbols. Therefore, aspects of the present disclosure provide solutions for configuring and operating SBFD-aware UEs in these scenarios. For instance, the UE or base station may manage these transitions by determining configuration transition periods before, during, or after the RO, applying scheduling restrictions, reporting UE capabilities for configuration transition periods, determining guard symbol lengths, and configuring SBFD and non-SBFD modes for special RACH occasions. Thus, the aspects of the present disclosure allow for a smooth transition and uninterrupted PRACH transmission across SBFD and non-SBFD symbols, enhancing the efficiency and speed of data communication in full duplex systems.

Accordingly, various aspects of the subject matter described in this disclosure relate generally to wireless communication systems, and more particularly to full duplex communication systems that allow for simultaneous transmission and reception of data. Some aspects specifically relate to the management of transitions between SBFD and non-SBFD modes in a UE during a RACH occasion. In various examples, apparatuses and methods are provided in which a wireless device receives or transmits a configuration of a RACH occasion spanning across at least a portion of a SBFD symbol, at least a portion of a subsequent non-SBFD symbol, and a transition period between the SBFD symbol and the subsequent non-SBFD symbol. The transition period is for transitioning between SBFD communications and non-SBFD communications without interruption of a RACH preamble transmission. The device also transmits or receives, in the RACH occasion, a RACH preamble in the SBFD symbol and the subsequent non-SBFD symbol before, during, or after a UE switch or a refrained UE switch from a first uplink configuration associated with the SBFD communications to a second uplink configuration associated with the non-SBFD communications during a configuration transition period. In some examples, the configuration transition period includes a first time period prior to a beginning of the RACH occasion in the SBFD symbol, a second time period following an end of the RACH occasion in the subsequent non-SBFD symbol, or a third time period within the transition period between the SBFD symbol and the subsequent non-SBFD symbol.

Additional aspects relate to the further operation of the apparatus or wireless device in managing transitions between SBFD and non-SBFD modes. Some aspects involve the apparatus switching to the second uplink configuration during a specific time period, which is specific to the apparatus. In another aspect, the apparatus determines whether a RACH occasion is valid for the RACH preamble transmission based on the presence of at least a guard period between a last symbol including downlink data and an initial symbol of the RACH occasion. In yet another aspect, the apparatus switches to the second uplink configuration during a transition period within the transition period between the SBFD symbol and the subsequent non-SBFD symbol, and transmits, in the RACH occasion, a RACH preamble in the SBFD symbol and the subsequent non-SBFD symbol without interrupting transmission of the RACH preamble during the transition period.

In further aspects, the UE switch to the second uplink configuration is responsive to a scheduling restriction for at least one of downlink data or uplink data during a quantity of guard symbols in at least one of the first time period based on a non-SBFD transmission capability of the apparatus for the RACH preamble transmission, or the second time period based on a SBFD transmission capability of the apparatus for the RACH preamble transmission. In another aspect, the RACH occasion is associated with one of an SBFD configuration or a non-SBFD configuration. In some instances, the apparatus transmits to a network entity, or receives from a UE, a capability indication of the one of the SBFD configuration or the non-SBFD configuration, the configuration of the RACH occasion being based on the capability indication. In yet another aspect, the apparatus receives from a network entity, or transmits to a UE, a radio resource control (RRC) configuration that indicates the one of the SBFD configuration or the non-SBFD configuration associated with the RACH occasion. In another aspect, the apparatus transmits to a network entity, or receives from a UE, an indication of one or more supported configurations among the SBFD configuration and the non-SBFD configuration; and receives from the network entity, or transmits to the UE, information that indicates the one of the SBFD configuration or the non-SBFD configuration selected from the one or more supported configurations for association with the RACH occasion.

In a further aspect, the apparatus transmits or receives, based on the RACH occasion being a valid RACH occasion for the RACH preamble transmission, an indication of a UE capability for switching from the first uplink configuration to the second uplink configuration, the indication including a selection of the configuration transition period from one of the first time period including a quantity of guard symbols prior to the beginning of the RACH occasion, the second time period including the quantity of guard symbols following the end of the RACH occasion, or the third time period within the transition period between the SBFD symbol and the subsequent non-SBFD symbol. In another aspect, the apparatus reports a first transmission time capability indicating a transition time between downlink SBFD reception and uplink SBFD transmission in one or more slots including the SBFD symbol; and reports a second transmission time capability indicating the configuration transition period for switching between the uplink SBFD transmission and an uplink non-SBFD transmission.

In yet another aspect, the RACH occasion is associated with an SBFD transmission configuration, and the RACH occasion is a valid RACH occasion for the RACH preamble transmission based on the presence of a first guard period between a last symbol including downlink data and an initial symbol of the RACH occasion, the first guard period having a duration of at least a transition time between downlink SBFD reception and uplink SBFD transmission in one or more slots including the SBFD symbol, and a second guard period between a last symbol of the RACH occasion and an initial symbol including uplink data, the second guard period having a duration of at least the configuration transition period for switching between the uplink SBFD transmission and an uplink non-SBFD transmission. In a further aspect, the RACH occasion is associated with a non-SBFD transmission configuration, and the RACH occasion is a valid RACH occasion for the RACH preamble transmission based on the presence of a guard period between a last symbol including downlink data and an initial symbol of the RACH occasion, the guard period having a duration of one of at least a combined transition time including a transition time between downlink SBFD reception and uplink SBFD transmission in one or more slots including the SBFD symbol, and the configuration transition period for switching between the uplink SBFD transmission and an uplink non-SBFD transmission, or at least a maximum transition time between the transition time and the configuration transition period.

Thus, particular aspects of the subject matter described in this disclosure may be implemented to realize one or more potential advantages. For example, the disclosed methods and apparatuses may enhance the efficiency and speed of data communication in full duplex systems by managing transitions between SBFD and non-SBFD modes during a RACH occasion without interrupting transmission of RACH preambles across the symbols. In various aspects, management of transitions between SBFD and non-SBFD modes may be achieved following reception or transmission of a configuration of a RACH occasion spanning across at least a portion of a SBFD symbol, at least a portion of a subsequent non-SBFD symbol, and a transition period between the SBFD symbol and the subsequent non-SBFD symbol. In these aspects, when the wireless device transmits or receives, in the RACH occasion, a RACH preamble in the SBFD symbol and the subsequent non-SBFD symbol before, during, or after a UE switch or refrained UE switch from a first uplink configuration associated with the SBFD communications to a second uplink configuration associated with the non-SBFD communications during a configuration transition period, a smooth transition and uninterrupted PRACH transmission across SBFD and non-SBFD symbols may be achieved. In addition, other aspects provide for the wireless device to switch to the second uplink configuration during a selected or configured time period before the RO, after the RO, or during the RO within the transition period between SBFD and non-SBFD symbols, to determine whether a RACH occasion is valid for the RACH preamble transmission before performing the switch, to determine whether to switch based on downlink or uplink scheduling restrictions, to switch based on an associated SBFD or non-SBFD configuration for the RACH occasion, to determine whether the SBFD or non-SBFD configuration is to be associated the RACH occasion based on one or more UE reported capabilities or network configurations, or any combination of at least the foregoing. Based on one or more of these aspects, the system can ensure that the transition between SBFD and non-SBFD modes is tailored to the specific capabilities of the apparatus, that the transition is performed at an optimal time, and that RACH preamble transmission is not interrupted, thereby enhancing the efficiency of the transition process.

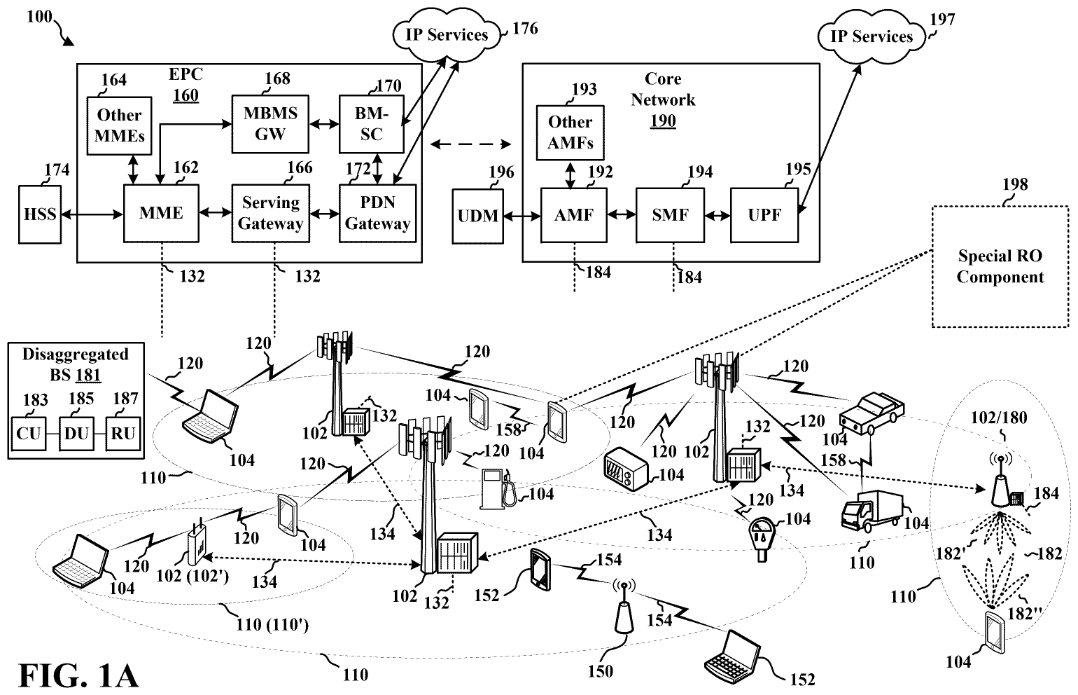

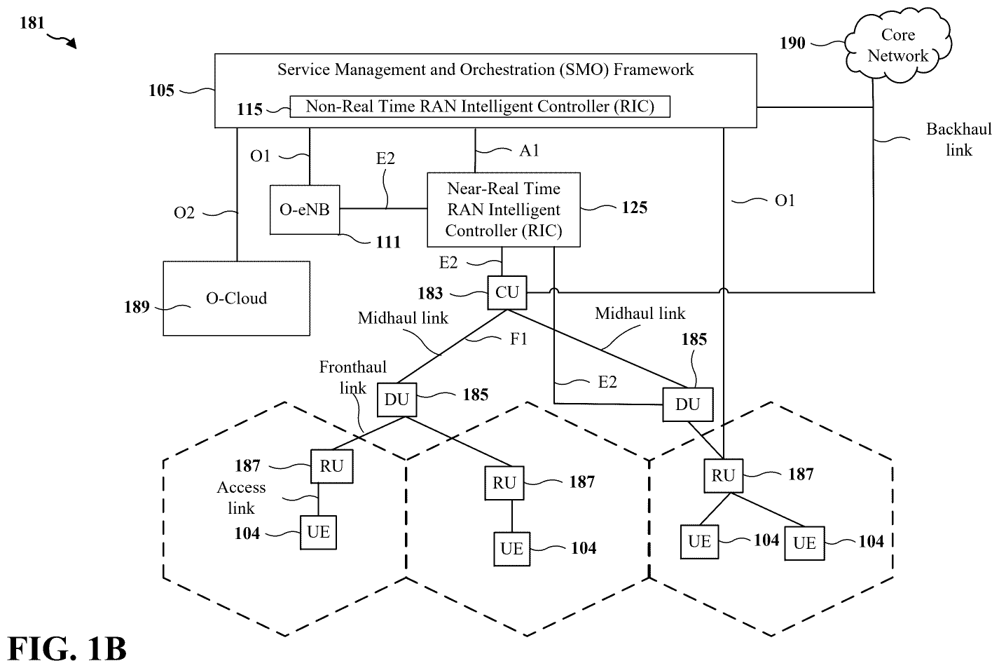

FIG. 1A is a diagram illustrating an example of a wireless communications system and an access network 100. The wireless communications system (also referred to as a wireless wide area network (WWAN)) includes base stations 102, user equipment(s) (UE) 104, an Evolved Packet Core (EPC) 160, and another core network 190 (e.g., a 5G Core (5GC)). The base stations 102 may include macrocells (high power cellular base station) and/or small cells (low power cellular base station). The macrocells include base stations. The small cells include femtocells, picocells, and microcells.

The base stations 102 configured for 4G Long Term Evolution (LTE) (collectively referred to as Evolved Universal Mobile Telecommunications System (UMTS) Terrestrial Radio Access Network (E-UTRAN)) may interface with the EPC 160 through first backhaul links 132 (e.g., S1 interface). The base stations 102 configured for 5G New Radio (NR) (collectively referred to as Next Generation RAN (NG-RAN)) may interface with core network 190 through second backhaul links 184. In addition to other functions, the base stations 102 may perform one or more of the following functions: transfer of user data, radio channel ciphering and deciphering, integrity protection, header compression, mobility control functions (e.g., handover, dual connectivity), inter-cell interference coordination, connection setup and release, load balancing, distribution for non-access stratum (NAS) messages, NAS node selection, synchronization, radio access network (RAN) sharing, Multimedia Broadcast Multicast Service (MBMS), subscriber and equipment trace, RAN information management (RIM), paging, positioning, and delivery of warning messages. The base stations 102 may communicate directly or indirectly (e.g., through the EPC 160 or core network 190) with each other over third backhaul links 134 (e.g., X2 interface). The first backhaul links 132, the second backhaul links 184, and the third backhaul links 134 may be wired or wireless.

The base stations 102 may wirelessly communicate with the UEs 104. Each of the base stations 102 may provide communication coverage for a respective geographic coverage area 110. There may be overlapping geographic coverage areas 110. For example, the small cell 102′ may have a coverage area 110′ that overlaps the coverage area 110 of one or more macro base stations 102. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links 120 between the base stations 102 and the UEs 104 may include uplink (UL) (also referred to as reverse link) transmissions from a UE 104 to a base station 102 and/or downlink (DL) (also referred to as forward link) transmissions from a base station 102 to a UE 104. The communication links 120 may use multiple-input and multiple-output (MIMO) antenna technology, including spatial multiplexing, beamforming, and/or transmit diversity. The communication links may be through one or more carriers. The base stations 102/UEs 104 may use spectrum up to Y megahertz (MHz) (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL WWAN spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, WiMedia, Bluetooth, ZigBee, Wi-Fi based on the Institute of Electrical and Electronics Engineers (IEEE) 802.11 standard, LTE, or NR.

The wireless communications system may further include a Wi-Fi access point (AP) 150 in communication with Wi-Fi stations (STAs) 152 via communication links 154, e.g., in a 5 gigahertz (GHz) unlicensed frequency spectrum or the like. When communicating in an unlicensed frequency spectrum, the STAs 152/AP 150 may perform a clear channel assessment (CCA) prior to communicating in order to determine whether the channel is available.

The small cell 102′ may operate in a licensed and/or an unlicensed frequency spectrum. When operating in an unlicensed frequency spectrum, the small cell 102′ may employ NR and use the same unlicensed frequency spectrum (e.g., 5 GHZ, or the like) as used by the Wi-Fi AP 150. The small cell 102′, employing NR in an unlicensed frequency spectrum, may boost coverage to and/or increase capacity of the access network.

The electromagnetic spectrum is often subdivided, based on frequency/wavelength, into various classes, bands, channels, etc. In 5G NR, two initial operating bands have been identified as frequency range designations FR1 (410 MHz-7.125 GHZ) and FR2 (24.25 GHz-52.6 GHz). The frequencies between FR1 and FR2 are often referred to as mid-band frequencies. Although a portion of FR1 is greater than 6 GHZ, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHZ-300 GHz) which is identified by the International Telecommunications Union (ITU) as a “millimeter wave” band.

With the above aspects in mind, unless specifically stated otherwise, it should be understood that the term “sub-6 GHz” or the like if used herein may broadly represent frequencies that may be less than 6 GHZ, may be within FR1, or may include mid-band frequencies. Further, unless specifically stated otherwise, it should be understood that the term “millimeter wave” or the like if used herein may broadly represent frequencies that may include mid-band frequencies, may be within FR2, or may be within the EHF band.

A base station 102, whether a small cell 102′ or a large cell (e.g., macro base station), may include and/or be referred to as an eNB, gNodeB (gNB), or another type of base station. Some base stations, such as gNB 180 may operate in a traditional sub 6 GHZ spectrum, in millimeter wave frequencies, and/or near millimeter wave frequencies in communication with the UE 104. When the gNB 180 operates in millimeter wave or near millimeter wave frequencies, the gNB 180 may be referred to as a millimeter wave base station. The millimeter wave base station 180 may utilize beamforming 182 with the UE 104 to compensate for the path loss and short range. The base station 180 and the UE 104 may each include a plurality of antennas, such as antenna elements, antenna panels, and/or antenna arrays to facilitate the beamforming.

The base station 180 may transmit a beamformed signal to the UE 104 in one or more transmit directions 182′. The UE 104 may receive the beamformed signal from the base station 180 in one or more receive directions 182″. The UE 104 may also transmit a beamformed signal to the base station 180 in one or more transmit directions. The base station 180 may receive the beamformed signal from the UE 104 in one or more receive directions. The base station 180/UE 104 may perform beam training to determine the best receive and transmit directions for each of the base station 180/UE 104. The transmit and receive directions for the base station 180 may or may not be the same. The transmit and receive directions for the UE 104 may or may not be the same.

The EPC 160 may include a Mobility Management Entity (MME) 162, other MMEs 164, a Serving Gateway 166, an MBMS Gateway 168, a Broadcast Multicast Service Center (BM-SC) 170, and a Packet Data Network (PDN) Gateway 172. The MME 162 may be in communication with a Home Subscriber Server (HSS) 174. The MME 162 is the control node that processes the signaling between the UEs 104 and the EPC 160. Generally, the MME 162 provides bearer and connection management. All user Internet protocol (IP) packets are transferred through the Serving Gateway 166, which itself is connected to the PDN Gateway 172. The PDN Gateway 172 provides UE IP address allocation as well as other functions. The PDN Gateway 172 and the BM-SC 170 are connected to the IP Services 176. The IP Services 176 may include the Internet, an intranet, an IP Multimedia Subsystem (IMS), a PS Streaming Service, and/or other IP services. The BM-SC 170 may provide functions for MBMS user service provisioning and delivery. The BM-SC 170 may serve as an entry point for content provider MBMS transmission, may be used to authorize and initiate MBMS Bearer Services within a public land mobile network (PLMN), and may be used to schedule MBMS transmissions. The MBMS Gateway 168 may be used to distribute MBMS traffic to the base stations 102 belonging to a Multicast Broadcast Single Frequency Network (MBSFN) area broadcasting a particular service, and may be responsible for session management (start/stop) and for collecting eMBMS related charging information.

The core network 190 may include an Access and Mobility Management Function (AMF) 192, other AMFs 193, a Session Management Function (SMF) 194, and a User Plane Function (UPF) 195. The AMF 192 may be in communication with a Unified Data Management (UDM) 196. The AMF 192 is the control node that processes the signaling between the UEs 104 and the core network 190. Generally, the AMF 192 provides Quality of Service (QOS) flow and session management. All user IP packets are transferred through the UPF 195. The UPF 195 provides UE IP address allocation as well as other functions. The UPF 195 is connected to the IP Services 197. The IP Services 197 may include the Internet, an intranet, an IMS, a Packet Switch (PS) Streaming Service, and/or other IP services.

The base station may include and/or be referred to as a gNB, Node B, cNB, an access point, a base transceiver station, a radio base station, a radio transceiver, a transceiver function, a basic service set (BSS), an extended service set (ESS), a transmit reception point (TRP), or some other suitable terminology. The base station 102 provides an access point to the EPC 160 or core network 190 for a UE 104. Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology.

Deployment of communication systems, such as 5G NR systems, may be arranged in multiple manners with various components or constituent parts. In a 5G NR system, or network, a network node, a network entity, a network device, a mobility element of a network, a RAN node, a core network node, a network element, or a network equipment, such as a BS, or one or more units (or one or more components) performing base station functionality, may be implemented in an aggregated or disaggregated architecture. For example, a BS (such as a Node B (NB), eNB, NR BS, 5G NB, access point (AP), a TRP, or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station 181 may be configured to utilize a protocol stack that is physically or logically distributed among two or more units (such as one or more central units (CU), one or more distributed units (DUs), or one or more radio units (RUs)). In some aspects, a CU 183 may be implemented within a RAN node, and one or more DUs 185 may be co-located with the CU, or alternatively, may be geographically or virtually distributed throughout one or multiple other RAN nodes. The DUs may be implemented to communicate with one or more RUs 187. Each of the CU, DU and RU also may be implemented as virtual units, i.e., a virtual central unit (VCU), a virtual distributed unit (VDU), or a virtual radio unit (VRU).

Base station-type operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which may enable flexibility in network design. The various units of the disaggregated base station, or disaggregated RAN architecture, may be configured for wired or wireless communication with at least one other unit.

FIG. 1B shows a diagram illustrating an example disaggregated base station 181 architecture. The disaggregated base station 181 architecture may include one or more CUs 183 that may communicate directly with core network 190 via a backhaul link, or indirectly with the core network 190 through one or more disaggregated base station units (such as a Near-Real Time RIC 125 via an E2 link, or a Non-Real Time RIC 115 associated with a Service Management and Orchestration (SMO) Framework 105, or both). A CU 183 may communicate with one or more DUs 185 via respective midhaul links, such as an F1 interface. The DUs 185 may communicate with one or more RUs 187 via respective fronthaul links. The RUs 187 may communicate respectively with UEs 104 via one or more radio frequency (RF) access links. In some implementations, the UE 104 may be simultaneously served by multiple RUs 187. Each of the units, i.e., the CUS 183, the DUs 185, the RUs 187, as well as the Near-RT RICs 125, the Non-RT RICs 115 and the SMO Framework 105, may include one or more interfaces or be coupled to one or more interfaces configured to receive or transmit signals, data, or information (collectively, signals) via a wired or wireless transmission medium. Each of the units, or an associated processor or controller providing instructions to the communication interfaces of the units, may be configured to communicate with one or more of the other units via the transmission medium. For example, the units may include a wired interface configured to receive or transmit signals over a wired transmission medium to one or more of the other units. Additionally, the units may include a wireless interface, which may include a receiver, a transmitter or transceiver (such as a radio frequency (RF) transceiver), configured to receive or transmit signals, or both, over a wireless transmission medium to one or more of the other units.

In some aspects, the CU 183 may host higher layer control functions. Such control functions may include radio resource control (RRC), packet data convergence protocol (PDCP), service data adaptation protocol (SDAP), or the like. Each control function may be implemented with an interface configured to communicate signals with other control functions hosted by the CU 183. The CU 183 may be configured to handle user plane functionality (i.e., Central Unit-User Plane (CU-UP)), control plane functionality (i.e., Central Unit-Control Plane (CU-CP)), or a combination thereof. In some implementations, the CU 183 may be logically split into one or more CU-UP units and one or more CU-CP units. The CU-UP unit may communicate bidirectionally with the CU-CP unit via an interface, such as the E1 interface when implemented in an O-RAN configuration. The CU 183 may be implemented to communicate with the DU 185, as necessary, for network control and signaling.

The DU 185 may correspond to a logical unit that includes one or more base station functions to control the operation of one or more RUs 187. In some aspects, the DU 185 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3rd Generation Partnership Project (3GPP). In some aspects, the DU 185 may further host one or more low PHY layers. Each layer (or module) may be implemented with an interface configured to communicate signals with other layers (and modules) hosted by the DU 185, or with the control functions hosted by the CU 183.

Lower-layer functionality may be implemented by one or more RUs 187. In some deployments, an RU 187, controlled by a DU 185, may correspond to a logical node that hosts RF processing functions, or low-PHY layer functions (such as performing fast Fourier transform (FFT), inverse FFT (IFFT), digital beamforming, physical random access channel (PRACH) extraction and filtering, or the like), or both, based at least in part on the functional split, such as a lower layer functional split. In such an architecture, the RU(s) 187 may be implemented to handle over the air (OTA) communication with one or more UEs 104. In some implementations, real-time and non-real-time aspects of control and user plane communication with the RU(s) 187 may be controlled by the corresponding DU 185. In some scenarios, this configuration may enable the DU(s) 185 and the CU 183 to be implemented in a cloud-based RAN architecture, such as a vRAN architecture.

The SMO Framework 105 may be configured to support RAN deployment and provisioning of non-virtualized and virtualized network elements. For non-virtualized network elements, the SMO Framework 105 may be configured to support the deployment of dedicated physical resources for RAN coverage requirements, which may be managed via an operations and maintenance interface (such as an O1 interface). For virtualized network elements, the SMO Framework 105 may be configured to interact with a cloud computing platform (such as an open cloud (O-Cloud) 189) to perform network element life cycle management (such as to instantiate virtualized network elements) via a cloud computing platform interface (such as an O2 interface). Such virtualized network elements may include, but are not limited to, CUs 183, DUs 185, RUs 187 and Near-RT RICs 125. In some implementations, the SMO Framework 105 may communicate with a hardware aspect of a 4G RAN, such as an open eNB (O-ENB) 111, via an O1 interface. Additionally, in some implementations, the SMO Framework 105 may communicate directly with one or more RUs 187 via an O1 interface. The SMO Framework 105 also may include the Non-RT RIC 115 configured to support functionality of the SMO Framework 105.

The Non-RT RIC 115 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 125. The Non-RT RIC 115 may be coupled to or communicate with (such as via an A1 interface) the Near-RT RIC 125. The Near-RT RIC 125 may be configured to include a logical function that enables near-real-time control and optimization of RAN elements and resources via data collection and actions over an interface (such as via an E2 interface) connecting one or more CUs 183, one or more DUs 185, or both, as well as an O-eNB, with the Near-RT RIC 125.

In some implementations, to generate AI/ML models to be deployed in the Near-RT RIC 125, the Non-RT RIC 115 may receive parameters or external enrichment information from external servers. Such information may be utilized by the Near-RT RIC 125 and may be received at the SMO Framework 105 or the Non-RT RIC 115 from non-network data sources or from network functions. In some examples, the Non-RT RIC 115 or the Near-RT RIC 125 may be configured to tune RAN behavior or performance. For example, the Non-RT RIC 115 may monitor long-term trends and patterns for performance and employ AI/ML models to perform corrective actions through the SMO Framework 105 (such as reconfiguration via 01) or via creation of RAN management policies (such as A1 policies).

Referring to FIGS. 1A and 1B, in certain aspects, the UE 104, aggregated base station (base station 102/180), one or more components of disaggregated base station 181 such as CU 183, DU 185, or RU 187, or some other network entity, may include a special RACH occasion (RO) component 198 that is configured to receive or transmit a configuration of a random access channel (RACH) occasion spanning across: at least a portion of a sub-band frequency division duplex (SBFD) symbol, at least a portion of a subsequent non-SBFD symbol in a same slot as or a different slot than the SBFD symbol, and a transition period between the SBFD symbol and the subsequent non-SBFD symbol. The transition period may be for transitioning between SBFD communications and non-SBFD communications without interruption of a RACH preamble transmission. The special RO component may further be configured to transmit or receive, in the RACH occasion, a RACH preamble in the SBFD symbol and the subsequent non-SBFD symbol before, during, or after a UE switch or refrained UE switch from a first uplink configuration associated with the SBFD communications to a second uplink configuration associated with the non-SBFD communications during a configuration transition period. The configuration transition period includes one of: a first time period prior to a beginning of the RACH occasion in the SBFD symbol, a second time period following an end of the RACH occasion in the subsequent non-SBFD symbol, or a third time period within the transition period between the SBFD symbol and the subsequent non-SBFD symbol. Although the present disclosure may focus on 5G NR, the concepts and various aspects described herein may be applicable to other similar areas, such as LTE, LTE-Advanced (LTE-A), Code Division Multiple Access (CDMA), Global System for Mobile communications (GSM), or other wireless/radio access technologies.

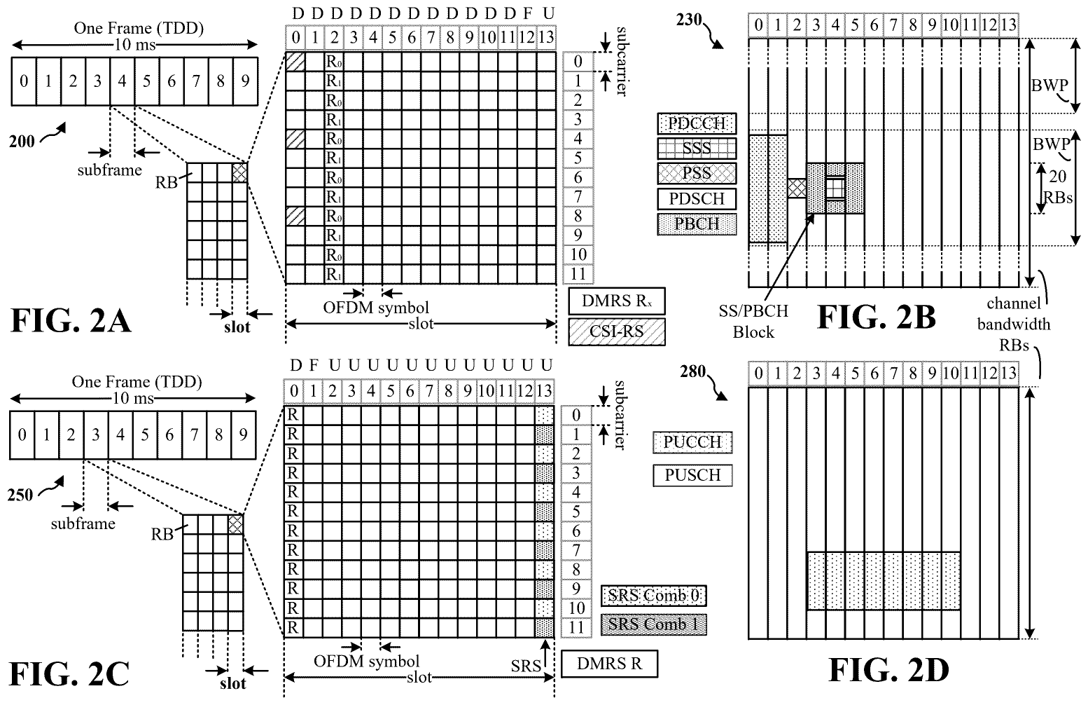

FIG. 2A is a diagram 200 illustrating an example of a first subframe within a 5G NR frame structure. FIG. 2B is a diagram 230 illustrating an example of DL channels within a 5G NR subframe. FIG. 2C is a diagram 250 illustrating an example of a second subframe within a 5G NR frame structure. FIG. 2D is a diagram 280 illustrating an example of UL channels within a 5G NR subframe. The 5G NR frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 2A, 2C, the 5G NR frame structure is assumed to be TDD, with subframe 4 being configured with slot format 28 (with mostly DL), where D is DL, U is UL, and F is flexible for use between DL/UL, and subframe 3 being configured with slot format 34 (with mostly UL). While subframes 3, 4 are shown with slot formats 34, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G NR frame structure that is TDD.

Other wireless communication technologies may have a different frame structure and/or different channels. A frame, e.g., of 10 milliseconds (ms), may be divided into 10 equally sized subframes (1 ms). Each subframe may include one or more time slots. Subframes may also include mini-slots, which may include 7, 4, or 2 symbols. Each slot may include 7 or 14 symbols, depending on the slot configuration. For slot configuration 0, each slot may include 14 symbols, and for slot configuration 1, each slot may include 7 symbols. The symbols on DL may be cyclic prefix (CP) orthogonal frequency-division multiplexing (OFDM) (CP-OFDM) symbols. The symbols on UL may be CP-OFDM symbols (for high throughput scenarios) or discrete Fourier transform (DFT) spread OFDM (DFT-s-OFDM) symbols (also referred to as single carrier frequency-division multiple access (SC-FDMA) symbols) (for power limited scenarios; limited to a single stream transmission). The number of slots within a subframe is based on the slot configuration and the numerology. For slot configuration 0, different numerologies μ 0 to 4 allow for 1, 2, 4, 8, and 16 slots, respectively, per subframe. For slot configuration 1, different numerologies 0 to 2 allow for 2, 4, and 8 slots, respectively, per subframe. Accordingly, for slot configuration 0 and numerology μ, there are 14 symbols/slot and 2μ slots/subframe. The subcarrier spacing and symbol length/duration are a function of the numerology. The subcarrier spacing may be equal to 2\hat{ }μ*15 kilohertz (kHz), where u is the numerology 0 to 4. As such, the numerology μ=0 has a subcarrier spacing of 15 kHz and the numerology μ=4 has a subcarrier spacing of 240 kHz. The symbol length/duration is inversely related to the subcarrier spacing. FIGS. 2A-2D provide an example of slot configuration 0 with 14 symbols per slot and numerology μ=2 with 4 slots per subframe. The slot duration is 0.25 ms, the subcarrier spacing is 60 kHz, and the symbol duration is approximately 16.67 μs. Within a set of frames, there may be one or more different bandwidth parts (BWPs) (see FIG. 2B) that are frequency division multiplexed. Each BWP may have a particular numerology.

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as Rx for one particular configuration, where 100× is the port number, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs), each CCE including nine RE groups (REGs), each REG including four consecutive REs in an OFDM symbol. A PDCCH within one BWP may be referred to as a control resource set (CORESET). Additional BWPs may be located at greater and/or lower frequencies across the channel bandwidth. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE may determine a physical cell identifier (PCI). Based on the PCI, the UE may determine the locations of the aforementioned DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) acknowledgement (ACK)/non-acknowledgement (NACK) feedback. The PUSCH carries data and may additionally be used to carry a buffer status report (BSR), a power headroom report (PHR), and/or UCI.

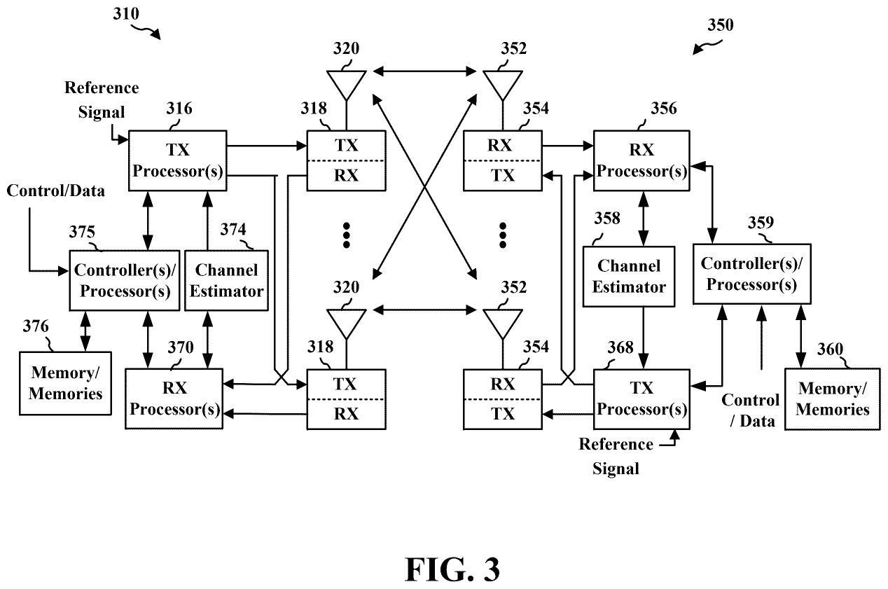

FIG. 3 is a block diagram of a base station 310 such as base station 102/180 in communication with a UE 350 such as UE 104 in an access network. IP packets from the EPC 160 may be provided to one or more controllers/processors 375 of base station 310. The one or more controllers/processors 375 implement layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The one or more controllers/processors 375 provide RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer protocol data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The one or more transmit (TX) processors 316 and the one or more receive (RX) processors 370 of base station 310 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The one or more TX processors 316 handle mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna 320 via a separate transmitter 318TX. Each transmitter 318TX may modulate an RF carrier with a respective spatial stream for transmission.

At the UE 350, each receiver 354RX receives a signal through its respective antenna 352. Each receiver 354RX recovers information modulated onto an RF carrier and provides the information to the one or more receive (RX) processors 356. The one or more TX processors 368 and the one or more RX processors 356 of UE 350 implement layer 1 functionality associated with various signal processing functions. The one or more RX processors 356 may perform spatial processing on the information to recover any spatial streams destined for the UE 350. If multiple spatial streams are destined for the UE 350, they may be combined by the one or more RX processors 356 into a single OFDM symbol stream. The one or more RX processors 356 then convert the OFDM symbol stream from the time-domain to the frequency domain using a Fast Fourier Transform (FFT). The frequency domain signal comprises a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are then decoded and deinterleaved to recover the data and control signals that were originally transmitted by the base station 310 on the physical channel. The data and control signals are then provided to the one or more controllers/processors 359 of UE 350, which implement layer 3 and layer 2 functionality.

The one or more controllers/processors 359 may each be associated with one or more memories 360 that store program codes and data. The one or more memories 360, individually or in any combination, may be referred to as a computer-readable medium and may be any of the types of computer-readable mediums discussed herein (e.g., RAM, ROM, EEPROM, optical disk storage, magnetic disk storage, other magnetic storage devices, combinations of the aforementioned types of computer-readable media, or any other medium that can be used to store computer executable code in the form of instructions or data structures that can be accessed by a computer). The one or more controllers/processors 359 provide demultiplexing between transport and logical channels, packet reassembly, deciphering, header decompression, and control signal processing to recover IP packets from the EPC 160. The one or more controllers/processors 359 are also responsible for error detection using an ACK and/or NACK protocol to support HARQ operations.

Similar to the functionality described in connection with transmission by the base station 310, the one or more controllers/processors 359 of UE 350 provide RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 310 may be used by the one or more TX processors 368 to select the appropriate coding and modulation schemes, and to facilitate spatial processing. The spatial streams generated by the one or more TX processors 368 may be provided to different antenna 352 via separate transmitters 354TX. Each transmitter 354TX may modulate an RF carrier with a respective spatial stream for transmission.

The transmission is processed at the base station 310 in a manner similar to that described in connection with the receiver function at the UE 350. Each receiver 318RX receives a signal through its respective antenna 320. Each receiver 318RX recovers information modulated onto an RF carrier and provides the information to one or more RX processors 370.

The one or more controllers/processors 375 may each be associated with one or more memories 376 that store program codes and data. The one or more memories 376, individually or in any combination, may be referred to as a computer-readable medium and may be any of the types of computer-readable mediums discussed herein (e.g., RAM, ROM, EEPROM, optical disk storage, magnetic disk storage, other magnetic storage devices, combinations of the aforementioned types of computer-readable media, or any other medium that can be used to store computer executable code in the form of instructions or data structures that can be accessed by a computer). The one or more controllers/processors 375 provide demultiplexing between transport and logical channels, packet reassembly, deciphering, header decompression, control signal processing to recover IP packets from the UE 350. IP packets from the one or more controllers/processors 375 may be provided to the EPC 160. The one or more controllers/processors 375 are also responsible for error detection using an ACK and/or NACK protocol to support HARQ operations.

At least one of the one or more TX processors 316, 368, the one or more RX processors 356, 370, and the one or more controllers/processors 359, 375, may be configured to perform aspects in connection with special RO component 198 of FIG. 1A.

Full duplex communication systems are wireless communication systems that allow for the simultaneous transmission and reception of data. In contrast, half-duplex communication systems are systems where data may be transmitted or received at any one time, not at the same time. The ability to transmit and receive data simultaneously can greatly enhance the efficiency and speed of data communication, making full duplex systems highly desirable in many applications.

There are two primary methods of achieving full duplex communication: in-band full duplex (IBFD) and sub-band frequency division duplexing (FDD, which is also known as flexible duplex or SBFD). IBFD is a method where both the transmission and reception of signals occur at the same time and on the same frequency resources. Thus, in IBFD, downlink (DL) and uplink (UL) communications may share the same time and frequency resources, which sharing may either include full overlap or partial overlap. The primary challenge in IBFD for UEs is managing self-interference, which is the interference caused by the device's own transmitted signal. On the other hand, SBFD, or flexible duplex, is a method where transmission and reception occur simultaneously, but they use different frequency resources. Thus, in SBFD, the downlink resource may separated from the uplink resource in the frequency domain. This method effectively reduces the issue of UE self-interference seen in IBFD, as the transmit and receive frequencies are different and do not overlap. Moreover, in SBFD, a guard band is usually placed between downlink and uplink frequencies, further reducing potential interference concerns.

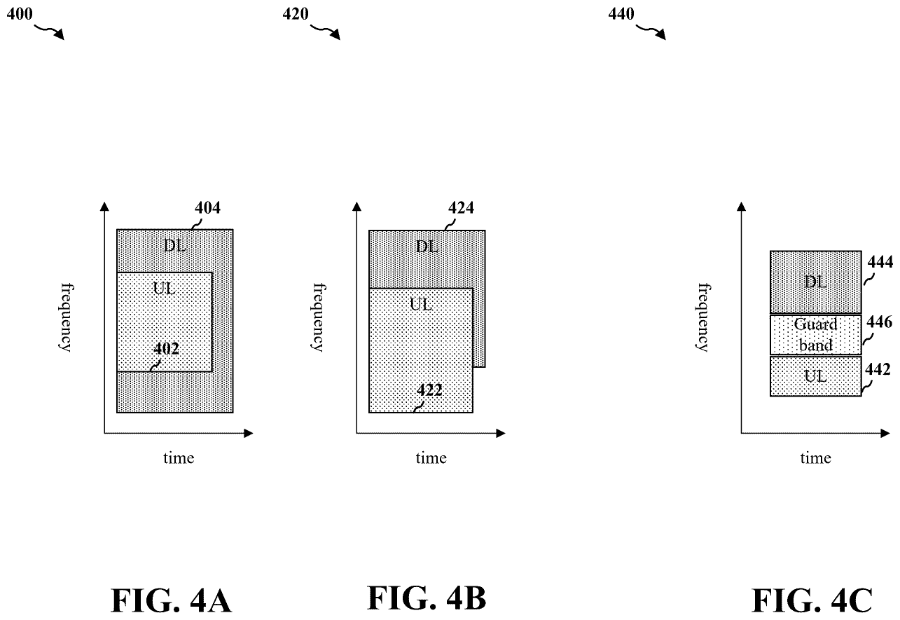

FIGS. 4A-4C illustrate examples 400, 420, 440 of full-duplex communication. FIGS. 4A and 4B refer to different examples of IBFD, in which a base station or UE may transmit and receive data in at least part of (or all of) the same frequency resource(s). For instance, in the example 400 of FIG. 4A, uplink frequency resources 402 may completely overlap with downlink frequency resources 404, while in the example 420 of FIG. 4B, uplink frequency resources 422 may partially overlap with downlink frequency resources 424. Moreover, FIG. 4C illustrates another example of full-duplex communication, namely SBFD or flexible duplex, in which a base station or UE may transmit and receive data in different frequency resources. For instance, in the example 440 of FIG. 4C, uplink frequency resources 442 and downlink frequency resources 444 may be separated by a guard band 446 in the frequency domain to minimize interference between the uplink and downlink frequency resources.

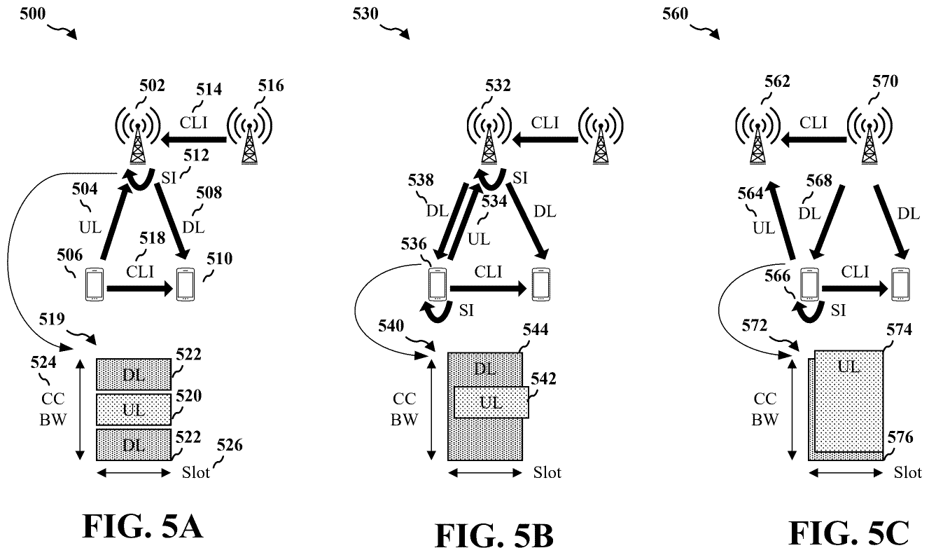

FIGS. 5A-5C illustrates different examples 500, 530, 560 of full duplex scenarios (e.g., SBFD or IBFD). In the example 500 of FIG. 5A, a base station 502 capable of full duplex communication may receive an uplink transmission 504 from a first UE 506 at the same time that the base station provides a downlink transmission 508 to a second UE 510. The first UE 506 and the second UE 510 may perform half duplex communication in this example. This scenario may result in self-interference (SI) 512 at the base station 502, cross link interference (CLI) 514 between the base station 502 and a neighbor base station 516, and CLI 518 between the first UE 506 and the second UE 510. To minimize this interference, SBFD 519 may be applied in which uplink frequency resources 520 for the uplink transmission 504 are separated from downlink frequency resources 522 for the downlink transmission 508 in a frequency band 524 (e.g., a component carrier (CC) bandwidth) and a slot 526.

In the example 530 of FIG. 5B, a base station 532 capable of full duplex communication (similar to base station 502) may receive an uplink transmission 534 from a UE 536 at the same time that the base station provides a downlink transmission 538 to the UE 536. The UE 536 may perform full duplex communication in this example. Similarly, in the example 560 of FIG. 5C, a base station 562 or first transmission-reception point (TRP) may receive an uplink transmission 564 from a UE 566 at the same time that the UE 566 obtains a downlink transmission 568 from a neighbor base station 570 or second TRP. The UE 566 may similarly perform full duplex communication in this example. Here, different examples of IBFD may be applied for the uplink and downlink communications. For instance, as illustrated in the example 530 of FIG. 5B, IBFD 540 may be applied in which uplink frequency resources 542 for the uplink transmission 534 partially overlap with downlink frequency resources 544 for the downlink transmission 538. Similarly, as illustrated in the example 560 of FIG. 5C, IBFD 572 may be applied in which uplink frequency resources 574 for the uplink transmission 564 may partially or totally overlap with downlink frequency resources 576 for the downlink transmission 568.

Thus, half duplex UEs and full duplex UEs may communicate with full duplex base stations using SBFD or IBFD, such as illustrated in FIGS. 4A-4C and 5A-5C. Half duplex UEs which support SBFD may also be referred to as SBFD-aware UEs. SBFD-aware UEs may become aware through signaling that the network is operating in SBFD. This awareness may be achieved either through direct signaling or through broadcast signaling that informs the UE about the time and frequency resources of the uplink and downlink bandwidth when the network is operating in SBFD. In this context, a SBFD-aware UE may still operate in a half-duplex mode, indicating it may only transmit or receive at any given time, not both simultaneously. Thus, a SBFD-aware UE indicates the UE is in half-duplex mode but is aware that the network is operating in full duplex mode across different sub-bands of the channel. This may be because the UE is not configured for full duplex operation even if it supports full duplex operation, the UE selects not to operate in a full duplex mode, or the UE is not capable to transmit and receive at the same time.

A SBFD-aware UE may perform SBFD random access operation. There are two types of random-access procedures for RRC (Radio Resource Control)-connected UEs that are currently defined, namely Type-1 (4-step RACH) and Type-2 (2-step RACH). These procedures play an important role in establishing the initial connection between the UE and the network, thereby setting the stage for wireless communication. The configuration of these RACH procedures may be managed by the base station through a RACH or PRACH configuration. This configuration may include parameters such as the number of preambles, the frequency and time resources for preamble transmission or RACH occasions, the power control settings, and the backoff parameters. The RACH occasions indicate what time and which frequency the UEs have the opportunity to initiate the RACH procedure.

The Type-1 or 4-step RACH procedure for initial access involves four steps: preamble transmission, random access response, message transmission, and contention resolution. The first step in this procedure is the transmission of a preamble. The UE selects a preamble from a set of available preambles and sends it to the base station in a RACH occasion. Upon receipt of the preamble, the base station responds with a random access response (RAR). This response includes timing advance information to correct any timing misalignment, uplink resource grants that allow the UE to send further messages, and a temporary identifier that distinguishes the UE in the subsequent process. The third step involves the UE utilizing the uplink resources granted in the RAR to transmit a connection request message to the base station. This message carries the UE's identity and the reason for the connection. The final step is contention resolution. After receiving the connection request, the base station sends a contention resolution message to confirm the establishment of the connection. If the UE successfully receives this message, the RACH procedure is deemed successful, and the UE is connected to the network. If not, the UE restarts the RACH procedure.

In comparison, the Type-2 or 2-step RACH procedure was designed with the aim of reducing latency and signaling overhead in Type-1 RACH. It simplifies the process by reducing the number of steps in the 4-step RACH procedure to two. In the first step of the 2-step RACH procedure, the UE selects a preamble from a set of available preambles and transmits it to the base station in the RACH occasion. Along with this preamble, the UE also sends a connection request message in that RACH occasion. This message includes the UE's identity and the reason for the connection. The inclusion of the connection request message in the first step simplifies the process compared to the 4-step RACH procedure and reduces the time taken for the UE to establish a connection. The second step of the 2-step RACH procedure involves the base station sending a message to the UE that includes timing advance information, uplink resource grants, a temporary identifier, and a contention resolution confirmation. This step combines the random access response and contention resolution steps of the 4-step procedure into a single step, further reducing latency and signaling overhead.

Both Type-1 and Type-2 RACH procedures can operate in two modes: contention-based or contention-free. In the contention-based random access mode, multiple UEs may attempt to access the network simultaneously using the same set of resources. This simultaneous access may lead to potential collisions, as the same preamble can be selected by more than one UE. When these UEs transmit their preambles at the same time in respective RACH occasions, the base station may not be able to distinguish between them, resulting in a collision. To manage these collisions, the base station employs a process known as contention resolution. After the UEs send their connection request messages, which include their identities, the base station sends a contention resolution message that includes the identity of the UE that it has successfully received the message from. If a UE receives this message and the identity matches its own, it knows that the RACH procedure has been successful. If not, it knows that a collision has occurred and it will restart the RACH procedure. On the other hand, contention-free random access offers a different approach. In this mode, the base station assigns specific resources to each UE, thereby avoiding collisions and ensuring smoother communication. The base station assigns a unique preamble to each UE, which means that no two UEs will attempt to access the network using the same preamble in a respective RACH occasion at the same time. This reduces the possibility of collisions and the need for contention resolution.

RACH occasions (ROs) for contention-based or contention-free, Type-1 and Type-2 RACH may occur in either SBFD or non-SBFD symbols. SBFD symbols refer to OFDM symbols that are associated at a given time with both uplink and downlink (or flexible) frequency resources. For instance, a SBFD symbol may include downlink frequency resources 444 and uplink frequency resources 442 such as illustrated in FIGS. 4C and 5A, within an OFDM symbol of a slot such as illustrated in FIGS. 2A and 2C. In contrast, non-SBFD symbols refer to OFDM symbols that are not associated at a given time with both uplink and downlink (or flexible) frequency resources. For instance, a non-SBFD symbol may include downlink frequency resources or uplink frequency resources, but not both at the same time, within an OFDM symbol of a slot such as illustrated in FIGS. 2A and 2C.

When it comes to random-access operation in SBFD symbols, multiple approaches for PRACH configurations may be considered. One approach, referred to as RACH configuration option 1, is to use a single shared RACH configuration for ROs in SBFD-symbols and ROs in non-SBFD symbols. Another approach, referred to as RACH configuration option 2, involves using two separate PRACH configurations, including one RACH configuration for non-SBFD symbols and an additional RACH configuration specifically for random-access in SBFD symbols. In some cases, a single RO indicated in one of these PRACH configurations may span across both SBFD and non-SBFD symbols. In either RACH configuration option, each PRACH configuration may be, for example, a common RACH configuration or a generic RACH configuration that includes one or more random access parameters indicating the time-frequency resources or other information regarding the RO(s).

For preamble transmission across both SBFD and non-SBFD symbols associated with separate PRACH configurations under at least RACH configuration option 2, it would be helpful to consider configurations for respective ROs starting from an SBFD symbol and ending in a non-SBFD symbol. These SBFD and non-SBFD symbols may occur either in the same slot or across different slots, based on network configuration. By default, a RO across SBFD symbols and non-SBFD symbols in the same slot or across slots is considered invalid. However, a configured RO that starts from an SBFD symbol and ends in a non-SBFD symbol, either in the same slot or across different slots, may be valid based on network configuration. This validity may be supported for the aforementioned RACH configuration option 2, specifically for those ROs configured by the additional RACH configuration.

If the network configures such an RO spanning across SBFD and non-SBFD symbols as a valid RO, the UE may treat the RO as an additional RO in SBFD symbols. The network and UE may make several assumptions for an RO that is considered to be valid. First, the same frequency resources may be used for both the SBFD segment and non-SBFD segment of the PRACH. Second, the same UL transmit power may be used for both the SBFD segment and non-SBFD segment of the PRACH. Third, the same UL spatial domain filter may be used for both the SBFD segment and non-SBFD segment of the PRACH. Fourth, the UE may not stop PRACH transmission in a transition period or gap, if any, between the SBFD segment and the non-SBFD segment. Fifth, there may be no phase coherency requirements on the UE between the SBFD segment and non-SBFD segment of the PRACH. Other assumptions are not precluded. For example, for Frequency Range 2 (FR), the network may ensure that an additional RO for SBFD symbols and an RO for non-SBFD symbols, which overlap with each other in the time domain, are mapped to the same synchronization signal block (SSB).

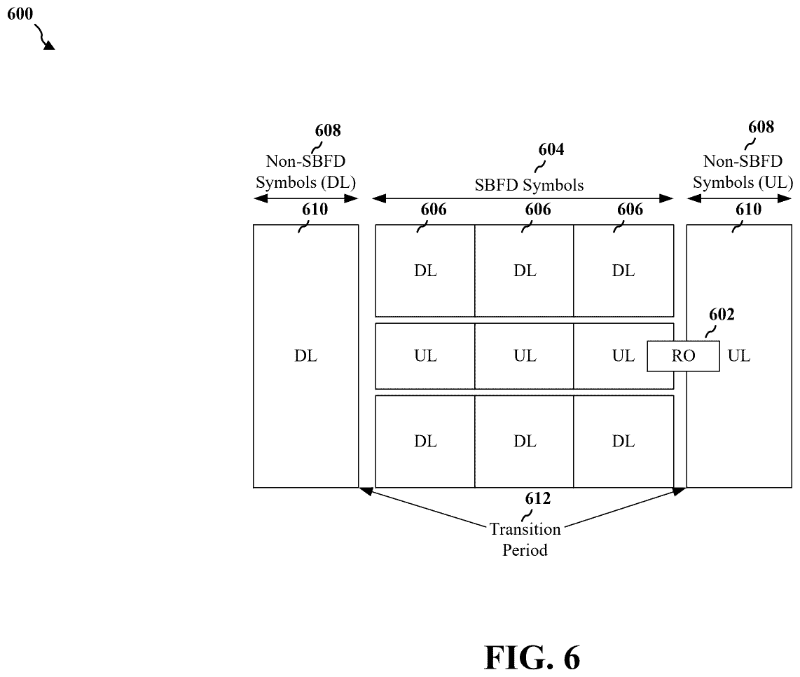

FIG. 6 illustrates an example 600 of a scenario where a configured RO 602 starts from an SBFD symbol 604 in a slot 606 and ends in a non-SBFD symbol 608 in a slot 610. Transition periods 612 separate SBFD symbols 604 from non-SBFD symbols 608. These transition periods 612 generally allow both the UE and the base station to change their transmission and reception configurations. Changes in transmission or reception configurations may include, for example, changes to Radio Frequency Front-End (RFFE) filters, radio frequency settings, sampling rates, transmission power, baseband switching, and the like. Such changes in configurations may allow the UE and base station to transition between an SBFD mode or SBFD configuration, where the UE performs uplink transmission in a narrower subband in SBFD symbols 604, and a non-SBFD mode or non-SBFD configuration, where the UE performs uplink transmission in a wider frequency band in uplink, non-SBFD symbols 608. Thus, an SBFD mode or SBFD configuration may be associated with one set of RFFE filters, baseband or radio frequency setting, sampling rate, transmission power, or a combination of any of the foregoing, while a non-SBFD mode or non-SBFD configuration may be associated with a different set of RFFE filters, baseband or radio frequency setting, sampling rate, transmission power, or a combination of any of the foregoing.

In such a scenario such as illustrated in FIG. 6, it would be helpful for a SBFD-aware UE to determine how to manage the transition period 612 or gap period from SBFD symbols 604 to non-SBFD symbols 608 in the case of an RO 602 which starts in SBFD symbols 604 and ends in non-SBFD symbols 608, referred to throughout this disclosure as a special RO. In particular, it would be helpful for such UEs to determine when, and whether, to switch its transmission configuration between SBFD symbols 604 and non-SBFD symbols 608 while ensuring uninterrupted PRACH transmission may still occur in such special ROs 602 across the transition period 612 between such symbols. To assist the UE in managing transitions between SBFD symbols 604 and non-SBFD symbols 608 with special ROs 602, various aspects of the present disclosure provide rules for SBFD-aware UE behavior in special ROs 602, scheduling restrictions, UE capabilities, guard symbol lengths, and configurations associated with special ROs.

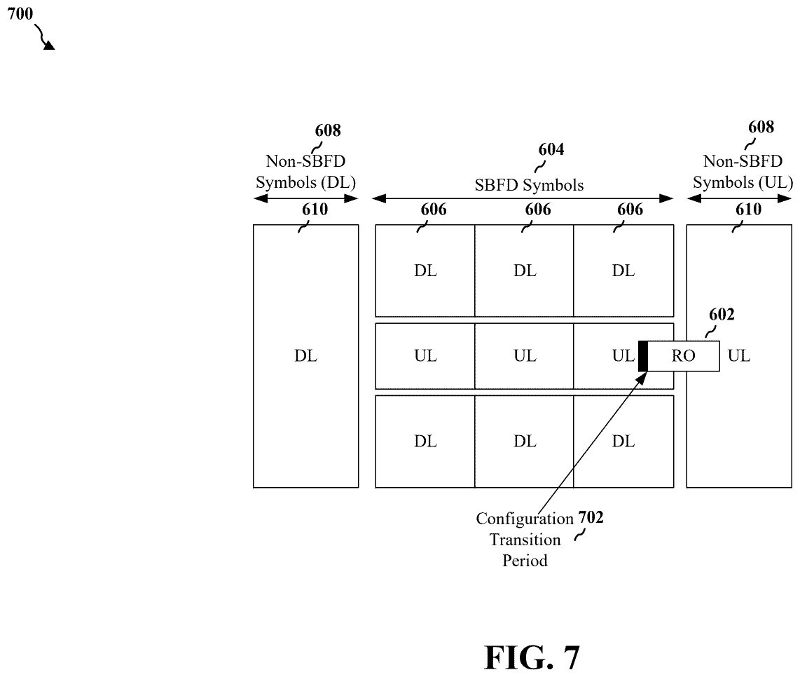

FIG. 7 illustrates an example 700 of a first aspect of the present disclosure providing SBFD-aware UE behavior in special ROs 602 between SBFD symbols 604 and non-SBFD symbols 608. In particular, a SBFD-aware UE may determine or be configured to change its configurations or settings from an SBFD state or mode to a non-SBFD state or mode right before the RO 602 starts. In particular, a configuration transition period 702 or guard period may be introduced at a time before the RO 602 begins, which transition period may be UE specific. This transition period 702 may apply to UEs which have an active, special RO 602 across SBFD symbols 604 and non-SBFD symbols 608 such as illustrated. Using this transition period 702, the UE may switch its configuration from the SBFD state to the non-SBFD state before beginning to send the PRACH transmission in the configured RO 602. The UE may then operate in the non-SBFD mode when sending the RACH preamble in the special RO 602, thereby ensuring a smooth transition and uninterrupted PRACH transmission across the SBFD and non-SBFD symbols.

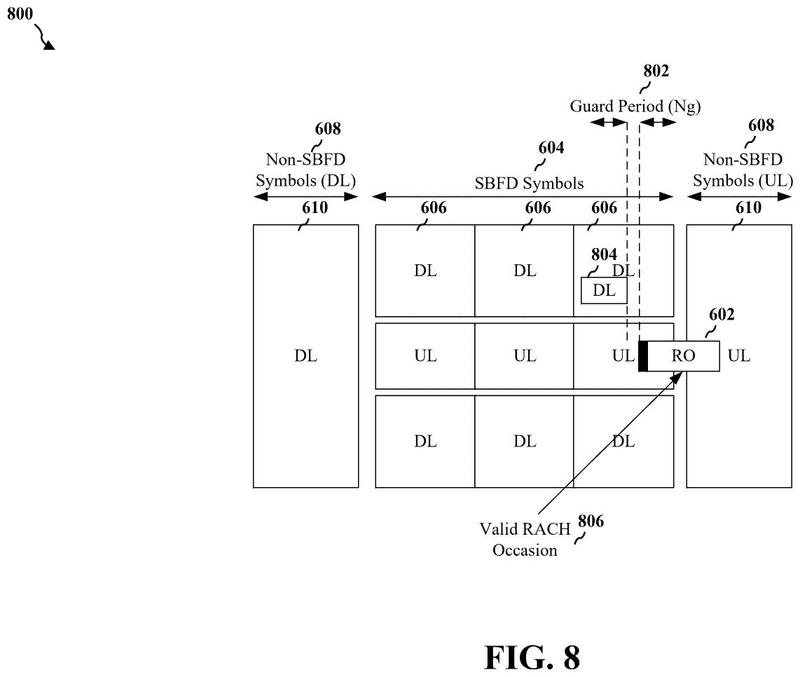

FIG. 8 illustrates an example 800 of a sub-aspect of the first aspect of the present disclosure providing one or more validity rules for special ROs 602 between SBFD symbols 604 and non-SBFD symbols 608. In particular, one or more rules may be provided based on which a SBFD-aware UE may determine whether a special RO 602 is valid for PRACH transmission across SBFD symbols 604 and non-SBFD symbols 608. In one example of a rule, the UE may determine whether a guard period 802 exists between a last SBFD downlink (DL) symbol including downlink data 804 and a first or initial symbol of the configured RO 602. The DL symbol in this context may refer to any symbol in which the UE receives or is intended to receive downlink data 804, such as an SSB, a channel state information reference signal (CSI-RS), a reference signal used for CLI measurement, or a physical downlink shared channel (PDSCH). If the UE determines that there is at least a guard period 802 of Ng symbols between the last DL symbol including such downlink data 804 and the first symbol of the configured RO, then the rule may be satisfied and the UE may consider the RO 602 starting in SBFD symbols 604 and ending in non-SBFD symbols 608 to be a valid RO 806 for PRACH transmission. The value or quantity of the Ng symbols in this rule, or the length of the guard period 802 considered in this rule, may be specific to a subcarrier spacing (SCS) associated with the subband in which the downlink data 804 is received. For example, one length of guard period 802 may be configured for a SCS of 15 kHz to satisfy the rule, another guard period length may be configured for a SCS of 30 kHz to satisfy the rule, and the like. Alternatively, the value of the Ng symbols or guard period length considered in this rule may be based on UE capability reporting, or it may pre-configured. For example, the UE may report in capability information to the base station the quantity of Ng symbols that the UE will consider satisfying the rule, or the quantity of Ng symbols satisfying the rule may be pre-defined.

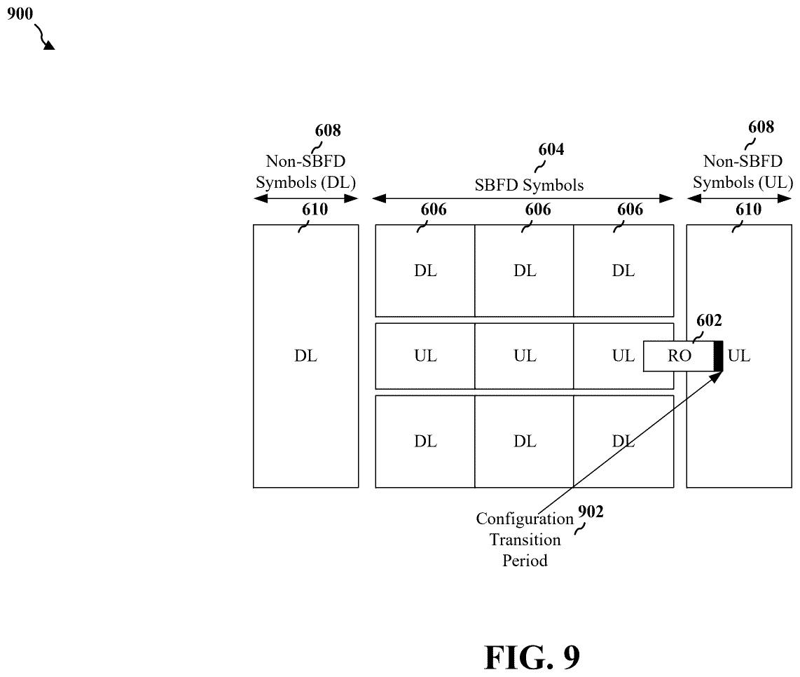

FIG. 9 illustrates an example 900 of a second aspect of the present disclosure providing SBFD-aware UE behavior in special ROs 602 between SBFD symbols 604 and non-SBFD symbols 608. This second aspect allows the UE to mitigate a possible interference effect that may result from the first aspect of the present disclosure in certain scenarios. More particularly, in that aspect where the transition period 702 is before the RO 602 such as illustrated in FIG. 7, the UE transitions to a non-SBFD configuration during SBFD symbols 604. However, this transition may potentially cause an increase in UE-to-UE interference impacting the PRACH transmission. For example, if the transmission power the UE applies in a non-SBFD mode is larger than a transmission power the UE may generally apply in SBFD symbols 604, the PRACH transmission in the RO 602 may interfere with communications to or from other nearby UEs. Therefore, according to the second aspect of the present disclosure, the UE may change its configuration or settings from an SBFD state to a non-SBFD state in a configuration transition period 902 right after the end of the RO 602, such as illustrated in FIG. 9. Thus, the UE may change its configuration to the non-SBFD mode after it has already completed its PRACH transmission in the special RO 602 while in the SBFD mode. This approach allows the UE to minimize the potential for increased UE-to-UE interference during the transition period 902 while still ensuring a smooth transition and uninterrupted PRACH transmission across the SBFD and non-SBFD symbols.

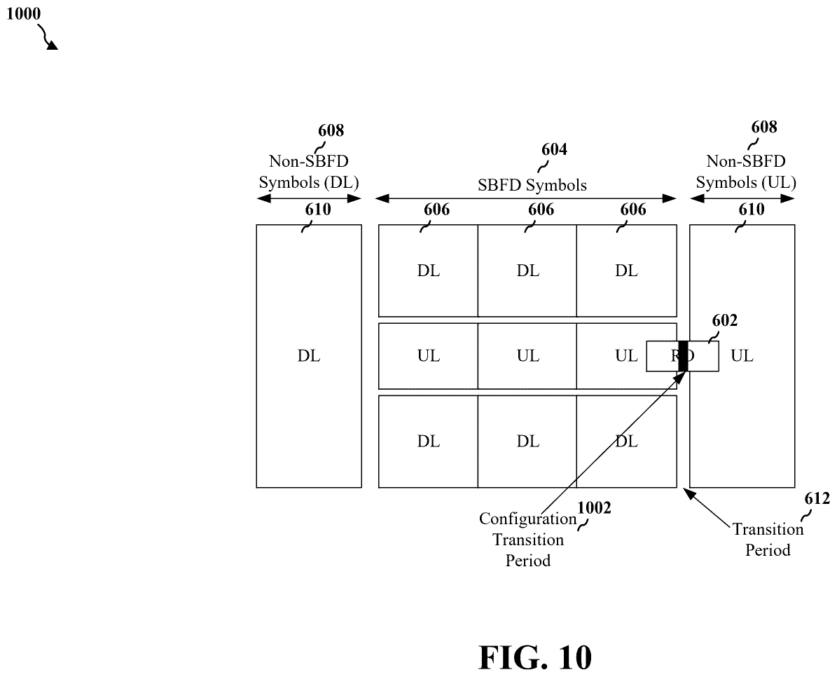

FIG. 10 illustrates an example 1000 of a third aspect of the present disclosure providing SBFD-aware UE behavior in special ROs 602 between SBFD symbols 604 and non-SBFD symbols 608. In this example, a UE may change its configuration or settings from a SBFD state to a non-SBFD state during the transition period 612 between SBFD symbols 604 and non-SBFD symbols 608. This change may occur under two different scenarios. In a first scenario, the UE may transmit a RACH preamble in an RO 602 across SBFD symbols 604 and non-SBFD symbols 608. In this case, the UE maintains the PRACH transmission across the SBFD and non-SBFD symbols. However, a transient period (tp) or configuration transition period 1002 may defined across samples of one or more last SBFD symbols and one or more first non-SBFD symbols within or around the transition period 612. During this transient period 1002, the UE may switch its configuration from a SBFD state to a non-SBFD state without stopping the PRACH transmission to change its configuration. For example, the UE may begin to transmit a RACH preamble in a SBFD mode with an associated transmission power for a portion of the transition period 612, reduce the transmission power of the RACH preamble to zero or nearly zero during the transient period 1002 while the UE switches its configuration to a non-SBFD mode, and then continue to transmit the RACH preamble in the non-SBFD mode with an associated transmission power for a remainder of the transition period 612. Thus, a smooth transition and uninterrupted PRACH transmission may be ensured. In a second scenario, the UE may not transmit any RACH preamble in the special RO 602. In this situation, the UE may leverage the transition period or gap across SBFD symbols 604 and non-SBFD symbols 608 to change the UE's configurations or settings between SBFD symbols and non-SBFD symbols without any PRACH transmission. These approaches allow the UE to prepare for the transition to non-SBFD symbols without interrupting any ongoing transmissions.

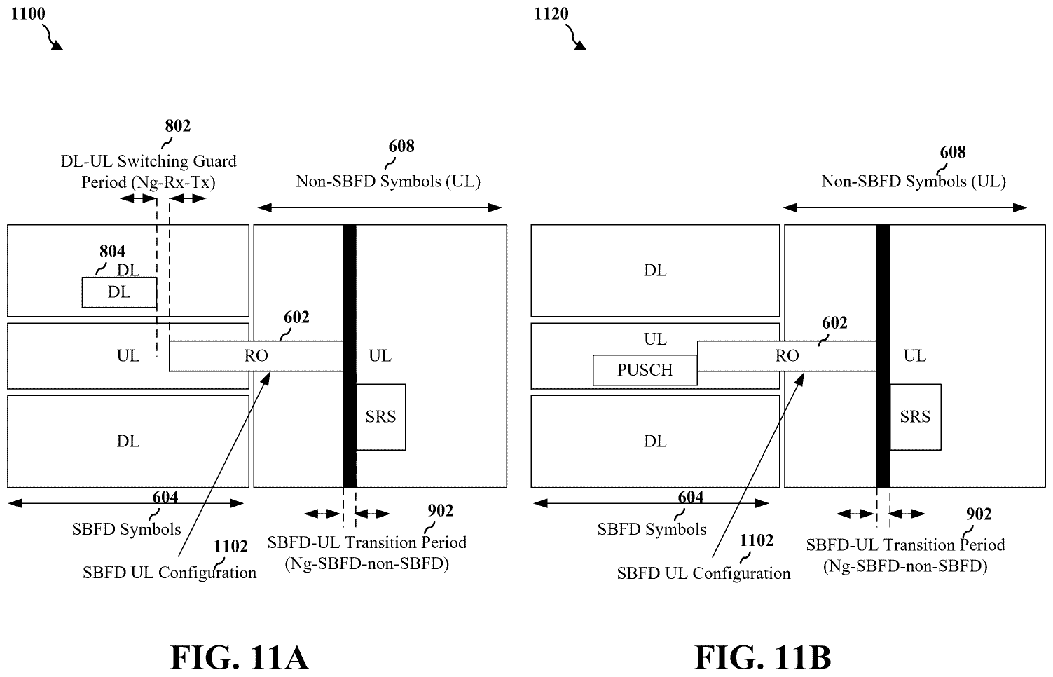

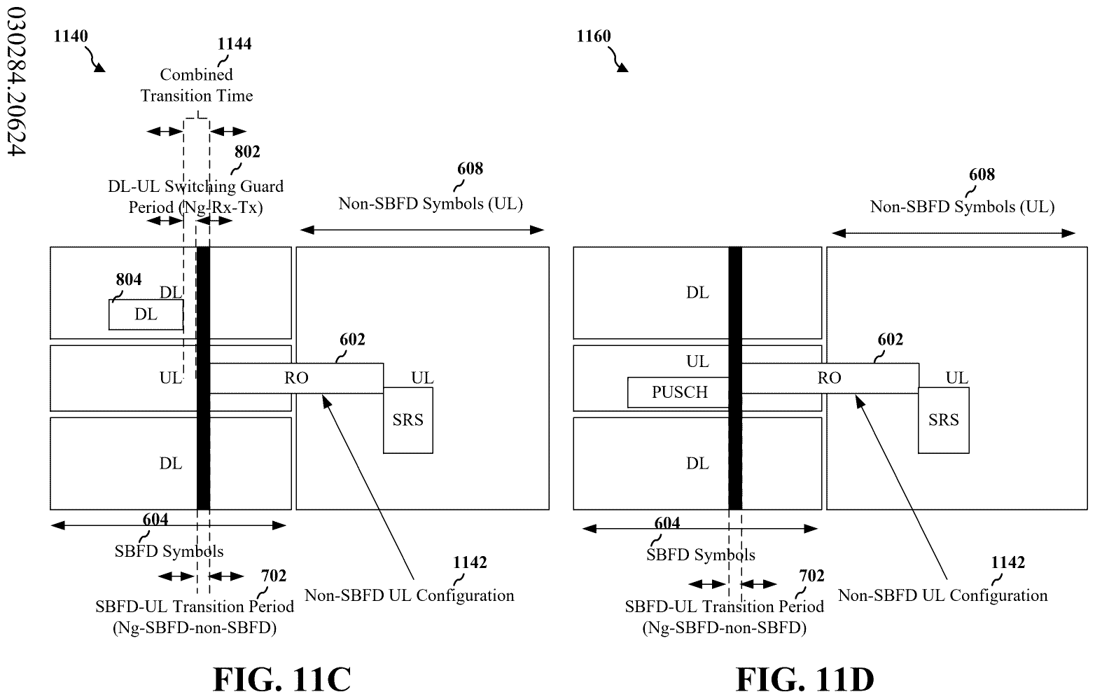

FIGS. 11A-11D illustrate various examples 1100, 1120, 1140, 1160 of additional aspects of the present disclosure providing scheduling restrictions, UE capabilities, guard symbol lengths, and configurations associated with special ROs spanning across SBFD symbols and non-SBFD symbols. In particular, FIGS. 11A-11B depict examples 1100, 1120 of special ROs 602 with SBFD uplink configurations 1102 in which the UE sends PRACH transmissions in those ROs 602 while in an SBFD mode with a configuration transition period 902 following the RO 602 such as described with respect to FIG. 9. In contrast, FIGS. 11C-11D depict examples 1140, 1160 of special ROs 602 with non-SBFD uplink configurations 1142 in which the UE sends PRACH transmissions in those ROs 602 while in a non-SBFD mode with a configuration transition period 702 preceding the RO 602 such as described with respect to FIG. 7.

In the examples 1100, 1120, 1140, 1160 of FIGS. 11A-11D, a guard period 802 may be configured for switching between downlink reception and uplink transmission, or a configuration transition period 702, 902 may be configured for the UE to transition between SBFD uplink transmission and non-SBFD uplink transmission. More particularly, for downlink to uplink switching, a number of guard symbols may be configured in a guard period 802 for the UE to switch between a downlink mode and an uplink SBFD mode. Moreover, the guard period 802 may be configured to accommodate for downlink and uplink timing differences resulting from timing advances and offsets for uplink timing compared to downlink timing. This guard period 802 or gap for DL to UL switching may also be different for SBFD symbols 604 and non-SBFD symbols 608. Additionally, for SBFD to non-SBFD switching, an additional transition time may be configured in a configuration transition period 702, 902 for the UE to tune its radio frequency settings and baseband settings to switch between a SBFD mode and a non-SBFD mode. This configuration transition period 702, 902 in these examples may correspond to any of the configuration transition periods in FIGS. 7-9.

In a fourth aspect of the present disclosure, a SBFD-aware UE may determine whether an uplink or downlink scheduling restriction is configured in a guard period 802 or configuration transition period 702, 902, such as the different sets of Ng symbols illustrated in FIGS. 11A-11D. Each guard period 802 or configuration transition period 702, 902 may precede or follow, or precede and follow, a RO 602 spanning across SBFD symbols 604 and non-SBFD symbols 608. If a scheduling restriction is configured or defined, the UE may switch between an SBFD mode and a non-SBFD mode for transmitting the RACH preamble in the special RO 602. As an example of scheduling restrictions, the UE may expect not to be scheduled for UL transmission, DL reception, or both UL transmission and DL reception, in any of the following guard periods 802 or configuration transition periods 702, 902: Ng symbols before a RO 602 spanning across SBFD symbols 604 and non-SBFD symbols 608 based on UE capability reporting, Ng symbols after a RO 602 spanning across SBFD symbols 604 and non-SBFD symbols 608 based on UE capability reporting, or in both the Ng symbols before and after the RO 602.

In one example, if the UE is configured to transition after the RO 602, the UE may have a downlink scheduling restriction in the Ng symbols before the RO 602 and an uplink scheduling restriction in the Ng symbols after the RO, such as illustrated in FIG. 11A, or just an uplink scheduling restriction in the Ng symbols after the RO 602, such as illustrated in FIG. 11B. In another example, if the UE is capable of transitioning before the RO 602, the UE may have a downlink scheduling restriction and an uplink scheduling restriction in different sets of Ng symbols before the RO 602, such as illustrated in FIG. 11C, or just an uplink scheduling restriction in Ng symbols before the RO 602, such as illustrated in FIG. 11D. In another example, the base station may conservatively apply both uplink and downlink scheduling restrictions in the various sets of Ng symbols before and after the RO 602 such as illustrated in any of FIGS. 11A-11D. If such scheduling restriction(s) are configured or applied in one or more of the guard periods 802 or configuration transition periods 702, 902 as previously described, the UE may determine that a special RO 602 spanning across SBFD symbols 604 and non-SBFD symbols 608 is valid for PRACH transmission, and the UE may switch between SBFD and non-SBFD modes for the transmission accordingly in the configuration transition periods 702, 902.

In a fifth aspect of the present disclosure, the UE or base station may determine whether an SBFD uplink configuration 1102, such as one set of RFFE filters, baseband or radio frequency setting, sampling rate, transmission power, or combination of any of the foregoing for SBFD transmissions, or a non-SBFD uplink configuration 1142, such as a different set of RFFE filters, baseband or radio frequency setting, sampling rate, transmission power, or combination of any of the foregoing for non-SBFD transmissions, is associated with a special RO 602 spanning across SBFD symbols 604 and non-SBFD symbols 608. If the UE determines that a SBFD uplink configuration 1102 is applied to the special RO 602, the UE may switch from a SBFD configuration or mode to a non-SBFD configuration or mode after the RO 602 in configuration transition period 902 such as illustrated in FIGS. 11A-11B. If the UE determines that a non-SBFD uplink configuration 1142 is applied to the special RO 602, the UE may switch from a SBFD configuration or mode to a non-SBFD configuration or mode before the RO 602 in configuration transition period 702 such as illustrated in FIGS. 11C-11D. The UE may determine whether a SBFD configuration 1102 or non-SBFD configuration 1142 is applied to a special RO 602, for example, based on one or more parameters indicated in a configuration from the base station. For example, the configuration may be an RRC configuration, such as the RACH configuration for the special RO 602 or a different configuration. For instance, a RACH configuration that indicates timing and other parameters of the RO 602 may further include a parameter indicating whether a configuration transition period 702, 902 for switching between SBFD and non-SBFD modes is located before or after the RO 602. If the configuration transition period is configured before the RO 602, then the UE may determine that the RO 602 is associated with a non-SBFD UL configuration 1142, while if the configuration transition period is configured after the RO 602, then the UE may determine that the RO 602 is associated with a SBFD UL configuration 1102.

Either the UE or base station may select which uplink configuration, the SBFD configuration 1102 or the non-SBFD configuration 1142, is to be applied to or configured for the special RO 602. In a first approach, the UE may determine a configuration 1102, 1142 which the UE is capable of applying to the special RO 602, and the UE may indicate the determined configuration 1102, 1142 as a UE capability to the base station. The base station may then configure the special RO 602 as associated with the SBFD configuration 1102 or non-SBFD configuration 1142 according to the indicated UE capability. In a second approach, the base station may determine or select a configuration 1102, 1142 which the UE is to apply to the special RO 602, and the base station may indicate the selected configuration 1102, 1142 to the UE in an RRC configuration for the special RO 602. The UE may then determine which configuration 1102, 1142 to apply for the RO 602, namely SBFD or non-SBFD, in response to the indicated RRC configuration. In a third approach, the UE may indicate one of multiple supported configurations among the uplink configurations the UE is capable of applying to the special RO, including the SBFD configuration 1102, the non-SBFD configuration 1142, or both configurations 1102, 1142. In response to the UE indication, the base station may determine or select one of the UE supported configurations which is to be applied for the RO, and the base station may indicate this selected configuration 1102, 1142 to the UE in a configuration such as an RRC configuration.

In a sixth aspect of the present disclosure, an SBFD-aware UE may report one of multiple UE capabilities for transitioning between SBFD symbols 604 and non-SBFD symbols 608. For instance, when the UE intends to transmit a preamble in an RO 602 spanning across SBFD symbols 604 and non-SBFD symbols 608 such as illustrated in any of FIGS. 11A-11D, the UE may indicate in a UE capability message to the base station that it is capable of switching or will switch its configuration from an SBFD mode to a non-SBFD mode in one of multiple configuration transition periods 702, 902. In particular, the UE may report one of the following components in its capability message to indicate a selected transition period for configuration switching: that the switch occurs within a period of Ng symbols prior to the start time of the RO 602 such as configuration transition period 702 illustrated in FIGS. 7, 8, and 11C-11D, that the switch occurs within a period of Ng symbols after an end time of the RO such as configuration transition period 902 illustrated in FIGS. 9 and 11A-11B, or that the switch occurs within a transition period 612 or gap between SBFD symbols 604 and non-SBFD symbols 608 such as configuration transition period 1002 illustrated in FIG. 10.

Furthermore, the UE may report in its capability message a quantity of Ng symbols which the UE may use to perform configuration switching from a SBFD mode to a non-SBFD mode before or after the special RO 602. For example, the UE may report a number of Ng symbols for configuration transition period 702, 902 selected from a set of values, such as 0, 1, 2, 4, or 8 symbols. In one example, the UE may report a same or different quantity of Ng symbols for each subcarrier spacing associated with a frequency band or uplink sub-band. For instance, the UE may report one value for Ng for a SCS of 15 kHz, another value for Ng for a SCS of 30 kHz, and the like. In another example, the UE may report a same quantity of Ng symbols across multiple or all subcarrier spacings. For instance, the UE may report a single value for Ng for SCSs of 15 kHz, 30 kHz, and the like. For any SCS, if the UE reports a value of 0 for the Ng symbols, the UE may indicate to the base station that it will not change its baseband or radio frequency configuration between an SBFD mode and a non-SBFD mode for special ROs in that configuration transition period 702, 902. For example, if the UE is to perform a PRACH transmission in frequency range 1 (FR1), the UE may determine to maintain its configuration or baseband or radio frequency settings across SBFD symbols 604 and non-SBFD symbols 608. In such case, the UE may refrain from switching its configuration in a configuration transition period 702, 902 associated with a particular SCS based on its reported value of 0 for a set of associated Ng symbols.

In a seventh aspect of the present disclosure, the UE may report multiple transition time capabilities for switching to the base station, including a first timing capability for switching from downlink SBFD reception to SBFD uplink transmission, and a second timing capability for switching from SBFD uplink transmission to non-SBFD uplink transmission. More particularly, for the first timing capability, the UE may report in a capability message a transition time Ng-Rx-Tx, which number of symbols corresponds to a duration of the guard periods 802 in FIGS. 11A and 11C. This transition time Ng-Rx-Tx may be provided as a top-level UE capability for a SBFD feature of the UE to switch between downlink and uplink in SBFD symbols 604. For the second timing capability, the UE may report in the capability message a transition time Ng-SBFD-non-SBFD, which number of symbols corresponds to a duration of the configuration transition periods 702, 902 in FIGS. 11A-11D. This transition time Ng-SBFD-non-SBFD may be provided as a UE capability for a special RO feature of the UE to transmit a RACH preamble in a RO 602 spanning SBFD symbols 604 and non-SBFD symbols 608.

In one example 1100 with reference to FIG. 11A, which depicts a special RO 602 having a SBFD UL configuration 1102, the UE may operate in a downlink mode before a start time of the RO 602. The UE may determine whether the guard period 802 or number of gap symbols configured before the RO 602 is at least Ng-Rx-Tx. If this timing is satisfied, the UE may switch from the downlink SBFD reception mode to an uplink SBFD transmission mode. The UE may also determine whether the configuration transition period 902 or number of gap symbols configured after the RO 602 is at least Ng-SBFD-non-SBFD. If this timing is also satisfied, the UE may switch from SBFD configuration 1102 to non-SBFD configuration 1142 in the configuration transition period 902 after sending the RACH preamble. The UE may also determine based on the satisfaction of the timings that the RO 602 spanning across the SBFD symbols 604 and non-SBFD symbols 608 is a valid RO 806 for uninterrupted PRACH transmission.

In another example 1120 with reference to FIG. 11B, which depicts a special RO 602 having a SBFD UL configuration 1102, the UE may operate in an uplink mode before a start time of the RO 602. Here, no guard period 802 or number of gap symbols Ng-Rx-Tx may be configured before the RO 602, since the UE is already in an uplink SBFD transmission mode. Instead, the UE may only determine whether the configuration transition period 902 or number of gap symbols configured after the RO 602 is at least Ng-SBFD-non-SBFD. If this timing is satisfied, the UE may switch from SBFD configuration 1102 to non-SBFD configuration 1142 in the configuration transition period 902 after sending the RACH preamble. The UE may also determine based on the satisfaction of the timings that the RO spanning across the SBFD symbols 604 and non-SBFD symbols 608 is a valid RO 806 for uninterrupted PRACH transmission.

In one example 1140 with reference to FIG. 11C, which depicts a special RO 602 having a non-SBFD UL configuration 1142, the UE may operate in a downlink mode before a start time of the RO 602. The UE may determine whether the guard period or number of gap symbols configured before the RO 602 is one of the following: at least a combined transition time 1144 including the guard period 802 (Ng-Rx-Tx) and the configuration transition period 702 (Ng-SBFD-non-SBFD), or at least a maximum transition time between the guard period 802 (Ng-Rx-Tx) and the configuration transition period 702 (Ng-SBFD-non-SBFD). The base station or network may select or define which of these transition times the UE is to consider, namely the combined transition time 1144 or the maximum transition time. For example, the base station may configure the UE to apply the combined transition time approach in more conservative scenarios, such as where it would be helpful for the UE to take additional time to first switch from a downlink reception mode to an SBFD UL configuration before switching afterwards to a non-SBFD UL configuration. Alternatively, the base station may configure the UE to apply the maximum transition time approach in less conservative scenarios, such as where it would be helpful for the UE to save time by bypassing the SBFD UL configuration and instead switching from the downlink reception mode directly to the non-SBFD UL configuration. If either the combined transition time 1144 or maximum transition time is satisfied (depending on whichever approach the UE applies), the UE may determine that the RO 602 spanning across the SBFD symbols 604 and non-SBFD symbols 608 is a valid RO 806 for uninterrupted PRACH transmission. Moreover, before sending the RACH preamble, the UE may switch from the downlink reception mode to the uplink SBFD transmission mode in the guard period 802 and switch from the SBFD configuration 1102 to the non-SBFD configuration 1142 in the configuration transition period 702, or the UE may switch from the downlink reception mode directly to the non-SBFD configuration 1142 during these transition period(s) 702, 802. Furthermore, no guard period or number of gap symbols may be configured after the RO 602, since the UE will have already transitioned to an uplink non-SBFD transmission mode at that time.

In one example 1160 with reference to FIG. 11D, which depicts a special RO 602 having a non-SBFD UL configuration 1142, the UE may operate in an uplink mode before a start time of the RO 602. The UE may determine whether the guard period or number of gap symbols configured before the RO is at least the configuration transition period 702 (Ng-SBFD-non-SBFD), which is the transition time for switching between an SBFD UL mode and a non-SBFD UL mode. If this transition time is satisfied, the UE may determine that the RO 602 spanning across the SBFD symbols 604 and non-SBFD symbols 608 is a valid RO 806 for uninterrupted PRACH transmission. Moreover, before sending the RACH preamble, the UE may switch from the SBFD configuration 1102 to the non-SBFD configuration 1142 in the configuration transition period 702. Furthermore, no guard period or number of gap symbols may be configured after the RO 602, since the UE will have already transitioned to an uplink non-SBFD transmission mode at that time.

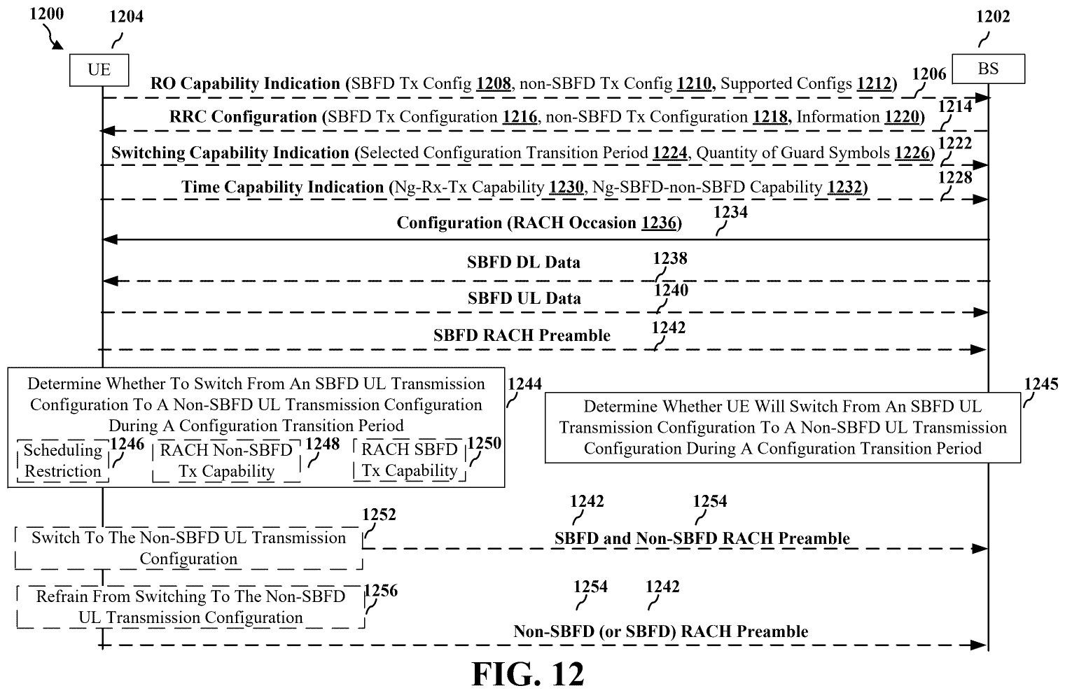

FIG. 12 illustrates an example 1200 of a call flow diagram between a base station 1202 and a UE 1204. Here, base station 1202 may correspond to base station 102, 310, and UE 1204 may correspond to UE 104, 350.

Initially, the UE 1204 may transmit and the base station 1202 may receive an RO capability indication 1206. The RO capability indication 1206 may indicate whether the UE 1204 is capable of sending a RACH preamble in a RACH occasion using an SBFD transmission configuration 1208, such as SBFD configuration 1102, or a non-SBFD transmission configuration 1210, such as non-SBFD configuration 1142. The RO capability indication 1206 may also indicate whether the UE 1204 supports either or both the SBFD configuration 1102 and non-SBFD configuration 1142 for RO 602 in an indication of supported configurations 1212. For example, the UE may indicate whether it is capable of SBFD transmissions in RO 602 such as illustrated in FIGS. 11A-11B or non-SBFD transmissions in RO 602 such as illustrated in FIGS. 11C-11D. Based on the indicated UE capability in RO capability indication 1206, the base station 1202 may configure a RACH configuration for RO 602 to indicate the RO's association with either the SBFD transmission configuration 1208 or non-SBFD transmission configuration 1210. For example, the base station may configure RO 602 to be associated with SBFD configuration 1102 or non-SBFD configuration 1142 in response to the UE's capability indication.

In another example, the UE 1204 may receive and the base station 1202 may transmit an RRC configuration 1214 that indicates a SBFD transmission configuration 1216 or a non-SBFD transmission configuration 1218 associated to a RACH occasion. For example, the base station may indicate in an RRC message whether SBFD configuration 1102 or non-SBFD configuration 1142 is to be applied to RO 602. Based on whichever configuration is indicated in the RRC configuration 1214, the UE may apply that configuration when it transmits a RACH preamble in the associated RACH occasion. For example, the UE may transmit a RACH preamble in RO 602 using the SBFD configuration 1102 such as illustrated in FIGS. 11A-11B or using the non-SBFD configuration 1142 such as illustrated in FIGS. 11C-11D in response to the RRC-configured message from the base station.

In a further example, the UE 1204 may transmit and the base station 1202 may receive, in RO capability indication 1206, the indication of one or more supported configurations 1212 among the SBFD transmission configuration 1208 and non-SBFD transmission configuration 1210. However, instead of expecting the RACH occasion to be associated with whichever configuration the UE indicates its capable of applying, here the UE may subsequently receive and the base station may subsequently transmit in RRC configuration 1214 an indication of which configuration the base station intends the UE to apply. More particularly, the base station may indicate in information 1220 that RO 602 is to be associated with whichever configuration the base station selects from the UE's supported configuration(s) 1212, including either the SBFD transmission configuration 1216 or the non-SBFD transmission configuration 1218. For example, the UE may indicate whether it is capable of or supports SBFD transmissions in RO 602 such as illustrated FIGS. 11A-11B, non-SBFD transmissions in RO 602 such as illustrated in FIGS. 11C-11D, or both, and the base station may select to apply either the SBFD configuration 1102 or non-SBFD configuration 1142 to the RO 602 in response to the UE's indication.

In an additional example, the UE 1204 may transmit and the base station 1202 may receive a switching capability indication 1222. The switching capability indication 1222 may be transmitted and received based on a RACH occasion, such as RO 602, being valid for RACH preamble transmission, such as valid RO 806. The switching capability indication 1222 may indicate the UE's capability for switching from the SBFD transmission configuration 1208, 1216 to the non-SBFD transmission configuration 1210, 1218 in a selected configuration transition period 1224. The selected configuration transition period 1224 may be either the configuration time period 702 including a quantity of guard symbols Ng-SBFD-non-SBFD prior to a start of the RACH occasion, the configuration time period 902 including a quantity of guard symbols Ng-SBFD-non-SBFD following an end of the RACH occasion, or the configuration time period 1002 in transition period 612 during which the UE may send samples of the RACH preamble transmission for example at zero transmission power. In another example, this switching capability indication 1222 may include a quantity of the guard symbols 1226, such as Ng-SBFD-non-SBFD, which the UE expects to be configured in the selected configuration transition period 1224. The quantity of the guard symbols 1226 may be associated with one or more subcarrier spacings. If the UE provides a quantity of zero guard symbols in Ng-SBFD-non-SBFD, the UE may indicate via the quantity of the guard symbols 1226 that the UE will refrain from switching during the selected configuration transition period 1224.

In another example, the UE 1204 may report and the base station 1202 may obtain a time capability indication 1228. The time capability indication 1228 may include a transmission time capability 1230 of the UE that indicates an amount of time Ng-Rx-Tx which the UE expects to use to switch from downlink SBFD reception to uplink SBFD transmission. Based on this transmission time capability 1230, the base station may determine that the UE may switch from downlink reception to uplink transmission using SBFD configuration 1102 if there are at least Ng-Rx-Tx symbols between downlink reception and uplink SBFD transmission in one or more slots including SBFD symbol(s) 604. The base station may then configure Ng-Rx-Tx accordingly based on the transmission time capability 1230, in response to which configuration the RO 602 may be deemed valid RO 806. Moreover, the time capability indication 1228 may include a transmission time capability 1232 indicating an amount of time Ng-SBFD-non-SBFD which the UE expects to use to switch from uplink SBFD transmission to uplink non-SBFD transmission. Based on this transmission time capability 1232, the base station may determine that the the UE may switch from SBFD configuration 1102 to non-SBFD configuration 1142 if there are at least Ng-SBFD-non-SBFD symbols between uplink SBFD transmission and uplink non-SBFD transmission such as within configuration transition period 702, 902. The base station may then configure Ng-SBFD-non-SBFD symbols accordingly based on the transmission time capability 1232, in response to which configuration the RO 602 may be deemed valid RO 806.

The UE 1204 may receive and the base station 1202 may transmit a configuration 1234 of a RACH occasion 1236. For example, configuration 1234 may be a RACH configuration or a PRACH configuration indicating time and frequency resources of RACH occasions or other parameters. The RACH occasion 1236 may correspond to RO 602. The RACH occasion 1236 may span across SBFD symbols 604, subsequent non-SBFD symbols 608 in a same or a different slot than the SBFD symbol(s), and transition period 612 between SBFD symbols 604 and non-SBFD symbols 608. The configuration 1234 of the RACH occasion 1236 may indicate whether SBFD transmission configuration 1208, 1216 or non-SBFD transmission configuration 1210, 1218 applies to RACH occasion 1236. For example, the configuration 1234 may indicate, either directly or via another configuration associated with configuration 1234 such as RRC configuration 1214, whether RACH occasion 1236 is associated with SBFD configuration 1102 or non-SBFD configuration 1142.

Following one or more of RO capability indication 1206, RRC configuration 1214, switching capability indication 1222, time capability indication 1228, configuration 1234, or any combination of the foregoing, the UE 1204 may communicate data with base station 1202 and transition between SBFD transmissions and non-SBFD transmissions without interrupting transmission of a RACH preamble in the transition period 612. In one example, the UE may receive and the base station may transmit SBFD downlink data 1238 such as DL data 804 in one or more SBFD symbols 604 using SBFD transmission configuration 1208, 1216, and the UE and base station may transition to an uplink configuration or setting for communication in RACH occasion 1236 according to transmission time capability 1230 within guard period 802 such as illustrated in FIG. 11A. Alternatively, the UE may transmit and the base station may receive SBFD uplink data 1240 in one or more SBFD symbols 604, in which case the UE and base station may already be in an uplink configuration or setting using SBFD transmission configuration 1208, 1216 such as illustrated in FIG. 11B. In the case where the selected configuration transition period 1224 is the configuration transition period 902 after the RO 602, as illustrated in FIGS. 9 and 11A-11B, the UE may transmit and the base station may receive a SBFD RACH preamble 1242 according to SBFD transmission configuration 1208, 1216 in the RACH occasion 1236.

At block 1244, the UE 1204 may determine whether to switch from a SBFD UL transmission configuration to a non-SBFD UL transmission configuration during a configuration transition period. Similarly, at block 1245, the base station 1202 may determine whether the UE will switch from the SBFD UL transmission configuration to the non-SBFD UL transmission configuration during the configuration transition period. For example, the UE and base station may determine whether the UE will switch from SBFD configuration 1102 to non-SBFD configuration 1142 during configuration transition period 702, 902 to send a RACH preamble in a RACH occasion 1236 across SBFD symbol(s) 604 and non-SBFD symbol(s) 608. In one example, the configuration transition period may be a first time period prior to a beginning of the RACH occasion 1236 in SBFD symbol(s) 604, such as configuration transition period 702. In another example, the configuration transition period may be a second time period following an end of the RACH occasion 1236 in subsequent non-SBFD symbol(s) 608, such as configuration transition period 902. In a further example, the configuration transition period may be a third time period within the transition period 612 between SBFD symbol(s) 604 and the subsequent non-SBFD symbol(s) 608, such as configuration transition period 1002.

In one example, at block 1244, the UE 1204 may determine whether to switch to the non-SBFD UL transmission based on presence of a scheduling restriction 1246 for downlink data, uplink data, or both types of data during a number of guard symbols Ng-SBFD-non-SBFD. The base station 1202 may similarly determine whether the UE will switch accordingly at block 1245. For example, if the UE determines that no SBFD DL data 1238 such as downlink data 804 is to be received in configuration transition period 702, that no uplink data such as a sounding reference signal (SRS) is to be sent in configuration transition period 902, or that no downlink data or uplink data is to respectively received or sent in either configuration transition period 702, 902, the UE 1204 may switch from SBFD configuration 1102 to non-SBFD configuration 1142 in one of the configuration transition periods 702, 902. For example, the UE may switch configurations in the configuration transition period 702 based on having a non-SBFD transmission capability 1248 for the RACH preamble transmission, or the UE may switch configurations in the configuration transition period 902 based on having a SBFD transmission capability 1250 for the RACH preamble transmission. The non-SBFD transmission capability 1248 may correspond to a UE capability to support the non-SBFD configuration 1142 for the RACH occasion 1236, while the SBFD transmission capability 1250 may correspond to a UE capability to support the SBFD configuration 1102 for the RACH occasion 1236. These UE capabilities may be indicated, for example, via SBFD transmission configuration 1208, non-SBFD transmission configuration 1210, or supported configurations 1212 in RO capability indication 1206.

The UE and base station may also determine that RACH occasion 1236 is valid RO 806 for PRACH transmission across SBFD symbol(s) 604 and non-SBFD symbol(s) 608. The UE may determine to make the switch at block 1244, and the base station may determine the UE will make the switch at block 1245, when the RACH occasion 1236 is a valid RACH occasion for RACH preamble transmission. For example, the UE and base station may determine that RACH occasion 1236 is valid RO 806 based on a presence of at least guard period 802 between a last symbol including downlink data 804 and an initial symbol of the RACH occasion 1236.

At block 1252, the UE 1204 may switch to the non-SBFD UL transmission configuration during one of the first time period, the second time period, or the third time period. The base station 1202, on the other hand, may switch to the non-SBFD UL transmission only during transient period 612 at block 1253, irrespectively of whether UE switches to the non-SBFD UL transmission configuration during one of the first time period, the second time period, or the third time period. More particularly, the UE may switch from SBFD transmission configuration 1208, 1216 to non-SBFD transmission configuration 1210, 1218 in selected configuration transition period 1224 according to transmission time capability 1232 within Ng-SBFD-non-SBFD symbols. In one example, the UE may switch during the configuration transition period 702, such as illustrated in FIGS. 7, 8 and 11C-11D. In another example, the UE may switch during the configuration transition period 902 following transmission of SBFD RACH preamble 1242, such as illustrated in FIG. 9 and FIGS. 11A-11B. In a further example, the UE may switch during the configuration transition period 1002, such as illustrated in FIG. 10.

Before, during, or after the UE 1204 makes the switch in the selected configuration transition period 1224, the UE may transmit and the base station may receive, in the RACH occasion 1236, a RACH preamble in the SBFD symbol(s) 604 and the subsequent non-SBFD symbol(s) 608 without interrupted transmission of the RACH preamble during the transition period 612. For example, in the case where the UE switches during configuration transition period 902, the UE may transmit and the base station may receive SBFD RACH preamble 1242 before the UE makes the switch. In the case where the UE switches during the configuration transition period 1002, the UE may transmit and the base station may receive SBFD RACH preamble 1242 in a portion of transition period 612 according to the SBFD configuration 1102, the UE may switch to the non-SBFD configuration 1142 during configuration transition period 1002 without interrupting RACH preamble transmission such as by applying zero transmission power to the preamble or in some other manner, and the UE may transmit and the base station may receive a non-SBFD RACH preamble 1254 during a remainder of the transition period 612 according to non-SBFD configuration 1142. In the case where the UE switches during the configuration transition period 702, the UE may transmit and the base station may receive non-SBFD RACH preamble 1254 after the UE makes the switch. In any of these cases, the RACH preamble 1242, 1254 may be transmitted and received in the RACH occasion 1236 spanning across SBFD symbols 604 and non-SBFD symbols 608.

Alternatively, at block 1256, the UE may refrain from switching to the non-SBFD UL transmission configuration during the configuration transition period. For example, the UE may refrain from switching, and the base station may determine at block 1245 that the UE will refrain from switching, if the UE reports zero guard symbols for Ng-SBFD-non-SBFD in switching capability indication 1222. In such case, following configuration transition period 702, 902, or 1002, the UE may transmit and the base station may receive only SBFD RACH preamble 1242 (not non-SBFD RACH preamble 1254) in RACH occasion 1236.

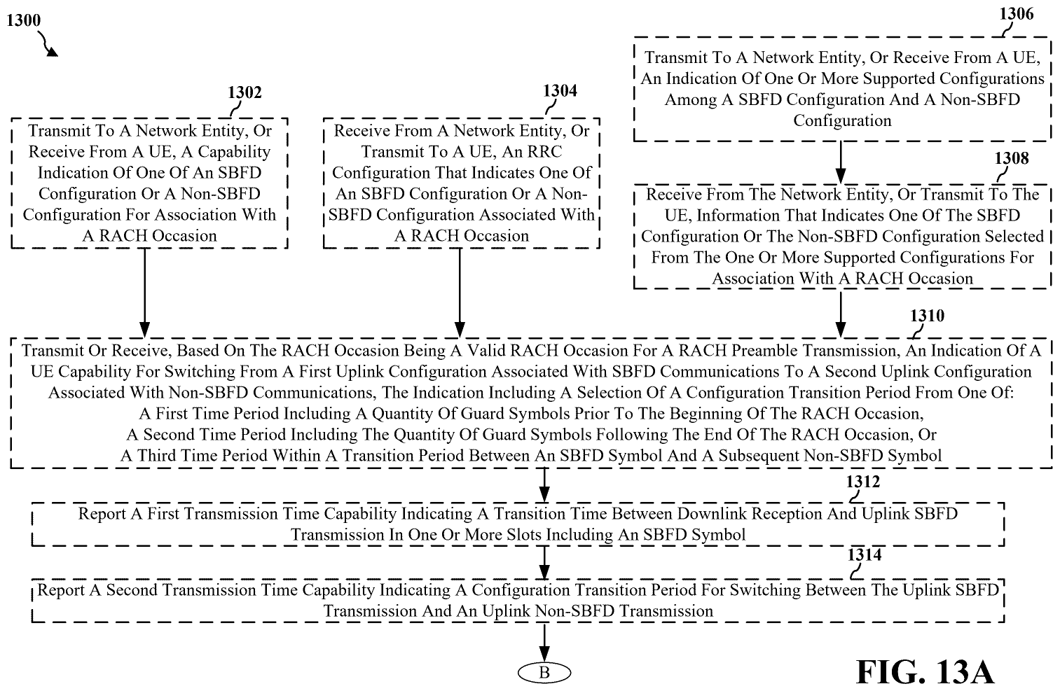

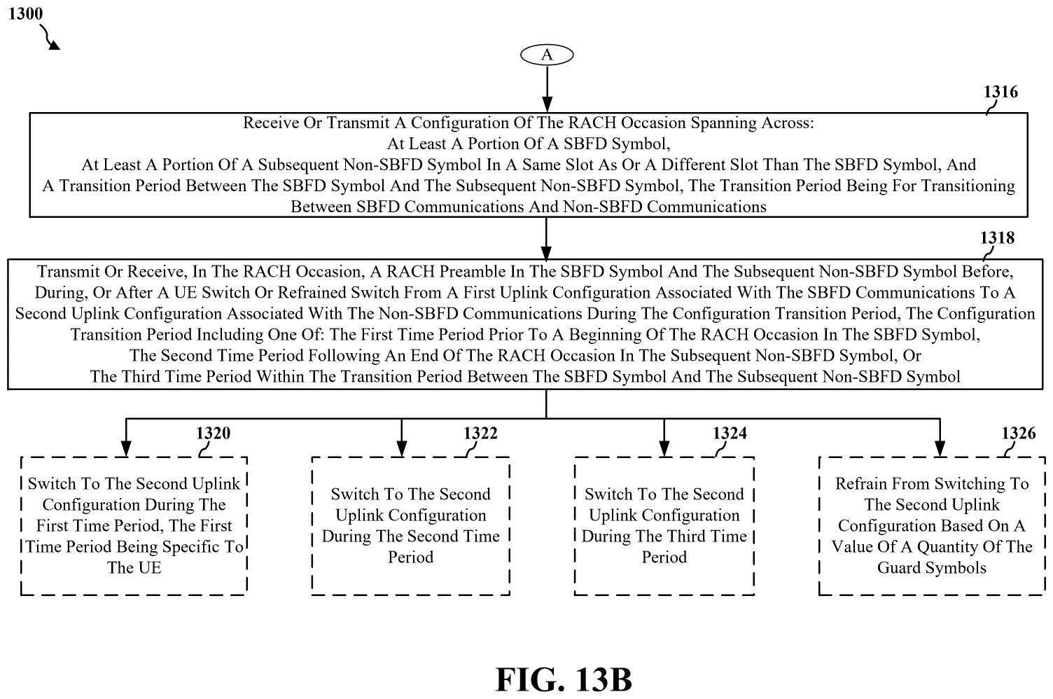

FIGS. 13A-13B are a flowchart 1300 of an example method or process for wireless communication. The method may be performed by a wireless device. The wireless device may be a UE such as the UE 104, 350, 1204, a network entity such as the base station 102/180, 310, 1202, disaggregated base station 181 or its components, or apparatus 1402 or its components as described herein. Optional aspects are illustrated in dashed lines. The method allows for the efficient management of transitions between SBFD and non-SBFD modes during a RACH occasion without interrupting transmission of RACH preambles across SBFD symbols and non-SBFD symbols.

Referring to FIG. 13A, at block 1302, the wireless device may transmit (if a UE) to a network entity, or receive (if a network entity) from a UE, a capability indication of one of a SBFD configuration or a non-SBFD configuration to be associated with a RACH occasion. For example, block 1302 may be performed by capability component 1440. For instance, referring to the Figures, the TX processor(s) 368 of UE 1204 may encode, modulate, and transmit via antennas 352, or the RX processor(s) 370 of base station 1202 may decode, demodulate, and receive via antennas 320, RO capability indication 1206 of SBFD transmission configuration 1208 or non-SBFD transmission configuration 1210 to be associated with RACH occasion 1236. For example, in the fifth aspect of the present disclosure, the UE may determine a configuration 1102, 1142 which the UE is capable of applying to the special RO 602, and the UE may indicate the determined configuration 1102, 1142 as a UE capability to the base station in RO capability indication 1206. The base station may then configure the special RO 602 as associated with the SBFD configuration 1102 or non-SBFD configuration 1142 according to the indicated UE capability.

At block 1304, the wireless device may receive (if a UE) from a network entity, or transmit (if a network entity) to a UE, a RRC configuration that indicates one of a SBFD configuration or a non-SBFD configuration associated with or to be associated with a RACH occasion. For example, block 1304 may be performed by configuration component 1442. For instance, referring to the Figures, the RX processor(s) 356 of UE 1204 may decode, demodulate, and receive via antennas 352, or the TX processor(s) 316 of base station 1202 may encode, modulate, and transmit via antennas 320, RRC configuration 1214 indicating SBFD transmission configuration 1216 or non-SBFD transmission configuration 1218 associated with or to be associated with RACH occasion 1236. For example, in the fifth aspect of the present disclosure, the base station may determine or select a configuration 1102, 1142 which the UE is to apply to the special RO 602, and the base station may indicate the selected configuration 1102, 1142 to the UE in RRC configuration 1214 for the special RO 602. The UE may then determine which configuration 1102, 1142 to apply for the RO 602, namely SBFD or non-SBFD, in response to the indicated RRC configuration.

At block 1306, the wireless device may transmit (if a UE) to a network entity, or receive (if a network entity) from a UE, an indication of one or more supported configurations among a SBFD configuration and a non-SBFD configuration to be associated with a RACH occasion. For example, block 1306 may be performed by capability component 1440. For instance, referring to the Figures, the TX processor(s) 368 of UE 1204 may encode, modulate, and transmit via antennas 352, or the RX processor(s) 370 of base station 1202 may decode, demodulate, and receive via antennas 320, supported configurations 1212 among SBFD transmission configuration 1208 and non-SBFD transmission configuration 1210 in RO capability indication 1206 to be associated with RACH occasion 1236. Subsequently, at block 1308, the wireless device may receive (if a UE) from the network entity, or transmit (if a network entity) to the UE, information that indicates the one of the SBFD configuration or the non-SBFD configuration selected from the one or more supported configurations for association with the RACH occasion. For example, block 1308 may be performed by configuration component 1442. For instance, referring to the Figures, the RX processor(s) 356 of UE 1204 may decode, demodulate, and receive via antennas 352, or the TX processor(s) 316 of base station 1202 may encode, modulate, and transmit via antennas 320, information 1220 indicating SBFD transmission configuration 1216 or non-SBFD transmission configuration 1218 selected from supported configurations 1212 for association with RACH occasion 1236. For example, in the fifth aspect of the present disclosure, the UE may indicate one of multiple supported configurations 1212 among the uplink configurations the UE is capable of applying to the special RO, including the SBFD configuration 1102, the non-SBFD configuration 1142, or both configurations 1102, 1142. In response to the UE indication, the base station may determine or select one of the UE supported configurations which is to be applied for the RO, and the base station may indicate this selected configuration 1102, 1142 to the UE in a configuration such as an RRC configuration via information 1220.

At block 1310, the wireless device may transmit (if a UE) or receive (if a network entity), based on the RACH occasion being a valid RACH occasion for a RACH preamble transmission, an indication of a UE capability for switching from a first uplink configuration associated with SBFD communications to a second uplink configuration associated with non-SBFD communications. For example, block 1310 may be performed by capability component 1440. For instance, referring to the Figures, the TX processor(s) 368 of UE 1204 may encode, modulate, and transmit via antennas 352, or the RX processor(s) 370 of base station 1202 may decode, demodulate, and receive via antennas 320, switching capability indication 1222 that the UE is capable of switching from SBFD transmission configuration 1208, 1216 to non-SBFD transmission configuration 1210, 1218. For example, in the sixth aspect of the present disclosure, an SBFD-aware UE may report one of multiple UE capabilities for transitioning between SBFD symbols 604 and non-SBFD symbols 608. For instance, when the UE intends to transmit a preamble in an RO 602 spanning across SBFD symbols 604 and non-SBFD symbols 608 such as illustrated in any of FIGS. 11A-11D, the UE may indicate in a UE capability message to the base station that it is capable of switching or will switch its configuration from an SBFD mode to a non-SBFD mode in one of multiple configuration transition periods 702, 902 via switching capability indication 1222.

The indication at block 1310 may include a selection of a configuration transition period from one of: a first time period including a quantity of guard symbols prior to the beginning of the RACH occasion, a second time period including the quantity of guard symbols following the end of the RACH occasion, or a third time period within a transition period between a last SBFD symbol and a subsequent first non-SBFD symbol or symbols. For instance, referring to the Figures, switching capability indication 1222 may include selected configuration transition period 1224 from configuration transition period 702 (the first time period), 902 (the second time period), or 1002 (the third time period). For example, in the sixth aspect of the present disclosure, the UE may report one of the following components in its capability message or switching capability indication 1222 to indicate a selected transition period for configuration switching: that the switch occurs within a period of Ng symbols or other quantity of guard symbols 1226 prior to the start time of the RO 602 such as configuration transition period 702 illustrated in FIGS. 7, 8, and 11C-11D, that the switch occurs within a period of Ng symbols or other quantity of guard symbols 1226 after an end time of the RO such as configuration transition period 902 illustrated in FIGS. 9 and 11A-11B, or that the switch occurs within a transition period 612 or gap between SBFD symbols 604 and non-SBFD symbols 608 such as configuration transition period 1002 illustrated in FIG. 10.

In some examples, the indication may further include the quantity of the guard symbols for one or more SCS. For instance, the switching capability indication 1222 may include the quantity of guard symbols 1226 for one or more SCS. For example, in the sixth aspect of the present disclosure, the UE may report in its capability message or switching capability indication 1222 a quantity of Ng symbols which the UE may use to perform configuration switching from a SBFD mode to a non-SBFD mode before or after the special RO 602. For example, the UE may report a number of Ng symbols for configuration transition period 702, 902 selected from a set of values, such as 0, 1, 2, 4, or 8 symbols. In one example, the UE may report a same or different quantity of Ng symbols for each subcarrier spacing associated with a frequency band or uplink sub-band. In another example, the UE may report a same quantity of Ng symbols across multiple or all subcarrier spacings.

At block 1312, the wireless device may report (if a UE) or obtain (if a network entity) a first transmission time capability indicating a transition time between downlink SBFD reception and uplink SBFD transmission in one or more slots including an SBFD symbol. For example, block 1312 may be performed by capability component 1440. For instance, referring to the Figures, the TX processor(s) 368 of UE 1204 may encode, modulate, and transmit via antennas 352, or the RX processor(s) 370 of base station 1202 may decode, demodulate, and receive via antennas 320, time capability indication 1228 including transmission time capability 1230. For example, in the seventh aspect of the present disclosure, for the first timing capability, the UE may report in a capability message or time capability indication 1228 a transition time Ng-Rx-Tx, which number of symbols corresponds to a duration of the guard periods 802 in FIGS. 11A and 11C. This transition time Ng-Rx-Tx may be provided as a top-level UE capability for a SBFD feature of the UE to switch between downlink and uplink in SBFD symbols 604. Moreover, at block 1314, the wireless device may report (if a UE) or obtain (if a network entity) a second transmission time capability indicating the configuration transition period for switching between the uplink SBFD transmission and an uplink non-SBFD transmission. For example, block 1314 may be performed by capability component 1440. For instance, referring to the Figures, the TX processor(s) 368 of UE 1204 may encode, modulate, and transmit via antennas 352, or the RX processor(s) 370 of base station 1202 may decode, demodulate, and receive via antennas 320, time capability indication 1228 including transmission time capability 1232. For example, in the seventh aspect of the present disclosure, for the second timing capability, the UE may report in the capability message or time capability indication 1228 a transition time Ng-SBFD-non-SBFD, which number of symbols corresponds to a duration of the configuration transition periods 702, 902 in FIGS. 11A-11D. This transition time Ng-SBFD-non-SBFD may be provided as a UE capability for a special RO feature of the UE to transmit a RACH preamble in a RO 602 spanning SBFD symbols 604 and non-SBFD symbols 608.

Referring now to FIG. 13B, at block 1316, the wireless device may receive (if a UE) or transmit (if a network entity) a configuration of a RACH occasion. For example, block 1316 may be performed by configuration component 1442. For instance, referring to the Figures, the RX processor(s) 356 of UE 1204 may decode, demodulate, and receive via antennas 352, or the TX processor(s) 316 of base station 1202 may encode, modulate, and transmit via antennas 320, configuration 1234 of RACH occasion 1236. The RACH occasion may be configured to span across: at least a portion of a SBFD symbol, at least a portion of a subsequent non-SBFD symbol in a same slot as or a different slot than the SBFD symbol, and a transition period between the SBFD symbol and the subsequent non-SBFD symbol. For example, RO 602 may span across SBFD symbol(s) 604, transition period 612, and non-SBFD symbol(s) 608. The transition period may be for transitioning between SBFD communications and non-SBFD communications without interruption of a RACH preamble transmission. For example, transition period 612 may separate SBFD symbols 604 from non-SBFD symbols 608 to allow both the UE and the base station to change their transmission and reception configurations, so that the UE and base station may switch between communication of a RACH preamble initially using SBFD configuration 1102 (referred to as SBFD RACH preamble 1242) and subsequently using non-SBFD configuration 1142 (referred to as non-SBFD RACH preamble 1254). This RACH preamble 1242, 1254 may be communicated across the transition period 612 without preamble transmission interruption within transition period 612.

In some examples, the configuration of the RACH occasion may include one of an SBFD configuration or a non-SBFD configuration. For instance, configuration 1234 of RACH occasion 1236 may include SBFD transmission configuration 1216 or non-SBFD transmission configuration 1218. For example, the base station may provide a RACH configuration or a PRACH configuration, or another configuration associated with the RACH configuration or PRACH configuration, which indicates whether SBFD configuration 1102 is associated with RO 602 or whether non-SBFD configuration 1142 is associated with RO 602. In one example, the configuration of the RACH occasion may be based on the capability indication at block 1302, the RRC configuration at block 1304, the indication at block 1306, the information at block 1308, the indication at block 1310, the first transmission time capability at block 1312, the second transmission time capability at block 1314, or any combination of the foregoing. For example, SBFD transmission configuration 1216 or non-SBFD transmission configuration 1218 may be selected, configured, or otherwise applied in the configuration of RACH occasion 1236 in response to, based on, or using RO capability indication 1206, RRC configuration 1214, switching capability indication 1222, time capability indication 1228, or a combination of any of the foregoing.

At block 1318, the wireless device may transmit (if a UE) or receive (if a network entity) a RACH preamble in the SBFD symbol and the subsequent non-SBFD symbol before, during, or after a UE switch or refrained switch from a first uplink configuration associated with the SBFD communications to a second uplink configuration associated with the non-SBFD communications during a configuration transition period. For example, block 1318 may be performed by switch component 1444 and preamble component 1446. For instance, referring to the Figures, the controller(s)/processor(s) 359 of UE 1204 or the controller(s)/processor(s) 375 of base station 1202 may determine, at block 1244 or 1245 respectively, whether the UE is to switch at block 1252 or not switch at block 1256 from SBFD configuration 1102 to non-SBFD configuration 1142 during configuration transition period 702, 902, or 1002. For example, the UE 1204 and base station 1202 may determine whether the UE is to switch, during the configuration transition period, from an SBFD mode or SBFD configuration associated with one set of RFFE filters, baseband or radio frequency setting, sampling rate, transmission power, other parameter(s), or a combination of any of the foregoing (for communication in a narrower sub band in SBFD), to a non-SBFD mode or non-SBFD configuration associated with a different set of RFFE filters, baseband or radio frequency setting, sampling rate, transmission power, other parameter(s), or a combination of any of the foregoing (for communication in a wider frequency band outside of SBFD). As an example of this determination process, the UE may identify whether the RACH occasion 1236 is a valid RO 806 for transmission of a RACH preamble across SBFD and non-SBFD symbols, and the UE may or may not switch its configuration from SBFD mode to non-SBFD mode during the configuration transition period in response to the identification. Following this determination, the TX processor(s) 368 of UE 1204 may encode, modulate, and transmit via antennas 352, or the RX processor(s) 370 of base station 1202 may decode, demodulate, and receive via antennas 320, RACH preamble 1242 or 1254 (or both) before, during, or after the UE switch at block 1252 or refrained switch at block 1256. For example, the UE may transmit and the base station may receive SBFD RACH preamble 1242, non-SBFD RACH preamble 1254, or both in RACH occasion 1236 spanning SBFD symbols 604 and non-SBFD symbols 608 without stopping RACH preamble transmission or reception during transition period 612. In some examples, the transition period may include the third time period, such as configuration transition period 1002.

In various examples, the configuration transition period may include one of: a first time period prior to a beginning of the RACH occasion in the SBFD symbol, a second time period following an end of the RACH occasion in the subsequent non-SBFD symbol, or a third time period within the transition period between the SBFD symbol and the subsequent non-SBFD symbol. For example, the configuration transition period may be the configuration transition period 702 prior to a start of RO 602 in SBFD symbols 604, the configuration transition period 902 following an end of RO 602 in non-SBFD symbols 608, or the configuration transition period 1002 within transition period 612 between SBFD symbols 604 and non-SBFD symbols 608.

In some examples, the RACH occasion may be a valid RACH occasion for the RACH preamble transmission based on a presence of at least a guard period between a last symbol including downlink data and an initial symbol of the RACH occasion. Alternatively or additionally, the RACH occasion may be a valid RACH occasion for the RACH preamble transmission based on a presence of at least a guard period between a last symbol of the RACH occasion and an initial symbol including uplink data. For instance, referring to the Figures, RACH occasion 1236 may be determined at block 1318 to be valid RO 806 for transmission of RACH preamble 1242 or 1254 based on a presence of at least Ng-Rx-Tx symbols, Ng-SBFD-non-SBFD symbols, a combination of Ng-Rx-Tx symbols and Ng-SBFD-non-SBFD symbols, a maximum (larger value) between Ng-Rx-Tx symbols and Ng-SBFD-non-SBFD symbols, or a combination of any of the foregoing, between a last SBFD symbol 604 including downlink data 804 (or uplink data) and an initial SBFD symbol of RO 602. Alternatively or additionally, the RACH occasion 1236 may be determined to be valid RO 806 at block 1318 based on a presence of any combination of at least Ng-SBFD-non-SBFD symbols between a last non-SBFD symbol 608 of RO 602 and an initial non-SBFD symbol of uplink data.

At block 1320, the wireless device may switch to the second uplink configuration during the first time period, the first time period being specific to the wireless device. For example, block 1320 may be performed by switch component 1444. For instance, referring to the Figures, the controller(s)/processor(s) 359 of UE 1204 may switch, at block 1252, to non-SBFD transmission configuration 1210, 1218 during configuration transition period 702. For example, in the first aspect of the present disclosure, a SBFD-aware UE may change its configurations or settings from an SBFD state or mode to a non-SBFD state or mode right before the RO 602 starts. In particular, a configuration transition period 702 or guard period may be introduced at a time before the RO 602 begins, which transition period may be UE specific.

At block 1322, the wireless device may switch to the second uplink configuration during the second time period. For example, block 1322 may be performed by switch component 1444. For instance, referring to the Figures, the controller(s)/processor(s) 359 of UE 1204 may switch, at block 1252, to non-SBFD transmission configuration 1210, 1218 during configuration transition period 902. For example, in the second aspect of the present disclosure, the UE may change its configuration or settings from an SBFD state to a non-SBFD state in a configuration transition period 902 right after the end of the RO 602. Thus, the UE may change its configuration to the non-SBFD mode after PRACH transmission has already been completed in the special RO 602 while in the SBFD mode.

At block 1324, the wireless device may switch to the second uplink configuration during the third time period. For example, block 1324 may be performed by switch component 1444. For instance, referring to the Figures, the controller(s)/processor(s) 359 of UE 1204 may switch, at block 1252, to non-SBFD transmission configuration 1210, 1218 during configuration transition period 1002. For example, in the third aspect of the present disclosure, the UE may change its configuration or settings from a SBFD state to a non-SBFD state during the transition period 612 between SBFD symbols 604 and non-SBFD symbols 608, without stopping the PRACH transmission to change its configuration. For example, the UE may begin to transmit a RACH preamble in a SBFD mode with an associated transmission power for a portion of the transition period 612, reduce the transmission power of the RACH preamble to zero or nearly zero during the transient period 1002 while the UE switches its configuration to a non-SBFD mode, and then continue to transmit the RACH preamble in the non-SBFD mode with an associated transmission power for a remainder of the transition period 612.

At block 1326, the wireless device may refrain from switching to the second uplink configuration based on a value of the quantity of the guard symbols indicated at block 1310. For example, block 1326 may be performed by switch component 1444. For instance, referring to the Figures, the controller(s)/processor(s) 359 of UE 1204 may refrain from switching, at block 1256, to non-SBFD transmission configuration 1210, 1218 based on a value of the quantity of guard symbols 1226 indicated in switching capability indication 1222. For example, in the sixth aspect of the present disclosure, for any SCS, if the UE reports a value of 0 for the Ng symbols, the UE may indicate to the base station that it will not change its baseband or radio frequency configuration between an SBFD mode and a non-SBFD mode for special ROs in that configuration transition period 702, 902. In such case, the UE may refrain from switching its configuration in a configuration transition period 702, 902 associated with a particular SCS based on the reported value of 0 for a set of associated Ng symbols.

In some examples, the UE switch to the second uplink configuration referenced at block 1318 may be responsive to a scheduling restriction for at least one of downlink data or uplink data during a quantity of guard symbols. For example, the UE or base station may determine at blocks 1244 and 1245 respectively whether the UE is to switch to non-SBFD transmission configuration 1210, 1218 based on scheduling restriction 1246 for downlink data 804 or uplink data (such as the SRS in FIGS. 11B and 11D) during Ng-SBFD-non-SBFD or other quantity of guard symbols 1226. For example, in the fourth aspect of the present disclosure, the UE and base station may determine whether an uplink or downlink scheduling restriction is configured in guard period 802 such as Ng-Rx-Tx or configuration transition period 702, 902 such as Ng-SBFD-non-SBFD. As an example of scheduling restrictions, the UE may expect not to be scheduled for UL transmission, DL reception, or both UL transmission and DL reception, in any of the following guard periods 802 or configuration transition periods 702, 902: Ng symbols before a RO 602 spanning across SBFD symbols 604 and non-SBFD symbols 608 based on UE capability reporting, Ng symbols after a RO 602 spanning across SBFD symbols 604 and non-SBFD symbols 608 based on UE capability reporting, or in both the Ng symbols before and after the RO 602. If a scheduling restriction is configured or defined, the UE may switch between an SBFD mode and a non-SBFD mode for transmitting the RACH preamble in the special RO 602.

The quantity of guard symbols may be in at least one of: the first time period based on a non-SBFD transmission capability of the wireless device for the RACH preamble transmission, or the second time period based on a SBFD transmission capability of the wireless device for the RACH preamble transmission. For instance, each guard period 802 or configuration transition period 702, 902 may precede or follow a RO 602 spanning across SBFD symbols 604 and non-SBFD symbols 608 based on non-SBFD transmission capability 1248 or SBFD transmission capability 1250 of the UE. For example, time period 702 may be configured for switching based on RO capability indication 1206 indicating a capability for non-SBFD transmission configuration 1210, or based on switching capability indication 1222 indicating configuration transition period 702 as selected configuration transition period 1224, while another time period 902 may be configured for switching based on RO capability indication 1206 indicating a capability for SBFD transmission configuration 1208, or based on switching capability indication 1222 indicating configuration transition period 902 as selected configuration transition period 1224.

In some examples, the RACH occasion may be associated with an SBFD transmission configuration, and the RACH occasion may be a valid RACH occasion for the RACH preamble transmission based on a presence of: a first guard period between a last symbol including downlink data and an initial symbol of the RACH occasion, and a second guard period between a last symbol of the RACH occasion and an initial symbol including uplink data. The first guard period may have a duration of at least a transition time between downlink reception and uplink SBFD transmission in one or more slots including the SBFD symbol. The second guard period may have a duration of at least the configuration transition period for switching between the uplink SBFD transmission and an uplink non-SBFD transmission. For instance, referring to FIG. 11A, RO 602 may be associated with SBFD configuration 1102, and RO 602 may be valid RO 806 for transmission of SBFD RACH preamble 1242 in response to there being at least Ng-Rx-Tx symbols between a last SBFD symbol 604 including downlink data 804 and an initial symbol of RO 602, and in response to there further being at least Ng-SBFD-non-SBFD symbols in configuration transition period 902 between a last symbol of RO 602 and an initial symbol including uplink data (such as the illustrated SRS).

In some examples, the RACH occasion may be associated with an SBFD transmission configuration, and the RACH occasion may be a valid RACH occasion for the RACH preamble transmission based on a presence of a guard period between a last symbol of the RACH occasion and an initial symbol including uplink data. The guard period may have a duration of at least the configuration transition period for switching between an uplink SBFD transmission and an uplink non-SBFD transmission. For instance, referring to FIG. 11B, RO 602 may be associated with SBFD configuration 1102, and RO 602 may be valid RO 806 for transmission of SBFD RACH preamble 1242 in response to there being at least Ng-SBFD-non-SBFD symbols in configuration transition period 902 between a last symbol of RO 602 and an initial symbol including uplink data (such as the illustrated SRS).

In some examples, the RACH occasion may be associated with a non-SBFD transmission configuration, and the RACH occasion may be a valid RACH occasion for the RACH preamble transmission based on a presence of a guard period between a last symbol including downlink data and an initial symbol of the RACH occasion. The guard period may have a duration of one of: at least a combined transition time including: a transition time between downlink SBFD reception and uplink SBFD transmission in one or more slots including the SBFD symbol, and the configuration transition period for switching between the uplink SBFD transmission and an uplink non-SBFD transmission, or at least a maximum transition time between the transition time and the configuration transition period. For instance, referring to FIG. 11C, RO 602 may be associated with non-SBFD configuration 1142, and RO 602 may be valid RO 806 for transmission of non-SBFD RACH preamble 1254 in response to there being at least combined transition time 1144 present including Ng-Rx-Tx symbols and Ng-SBFD-non-SBFD symbols in configuration transition period 702, or in response to there being present at least a larger of the two transition times given by Ng-Rx-Tx symbols and Ng-SBFD-non-SBFD symbols, between a last SBFD symbol 604 including downlink data 804 and an initial symbol of RO 602.

In some examples, the RACH occasion may be associated with a non-SBFD transmission configuration, and the RACH occasion may be a valid RACH occasion for the RACH preamble transmission based on a presence of a guard period between a last symbol including uplink data and an initial symbol of the RACH occasion. The guard period may have a duration of at least the configuration transition period for switching between an uplink SBFD transmission and an uplink non-SBFD transmission. For instance, referring to FIG. 11D, RO 602 may be associated with non-SBFD configuration 1142, and RO 602 may be valid RO 806 for transmission of non-SBFD RACH preamble 1254 in response to there being at least Ng-SBFD-non-SBFD symbols in configuration transition period 702 between a last symbol of uplink data (such as the illustrated PUSCH) and an initial symbol of RO 602.

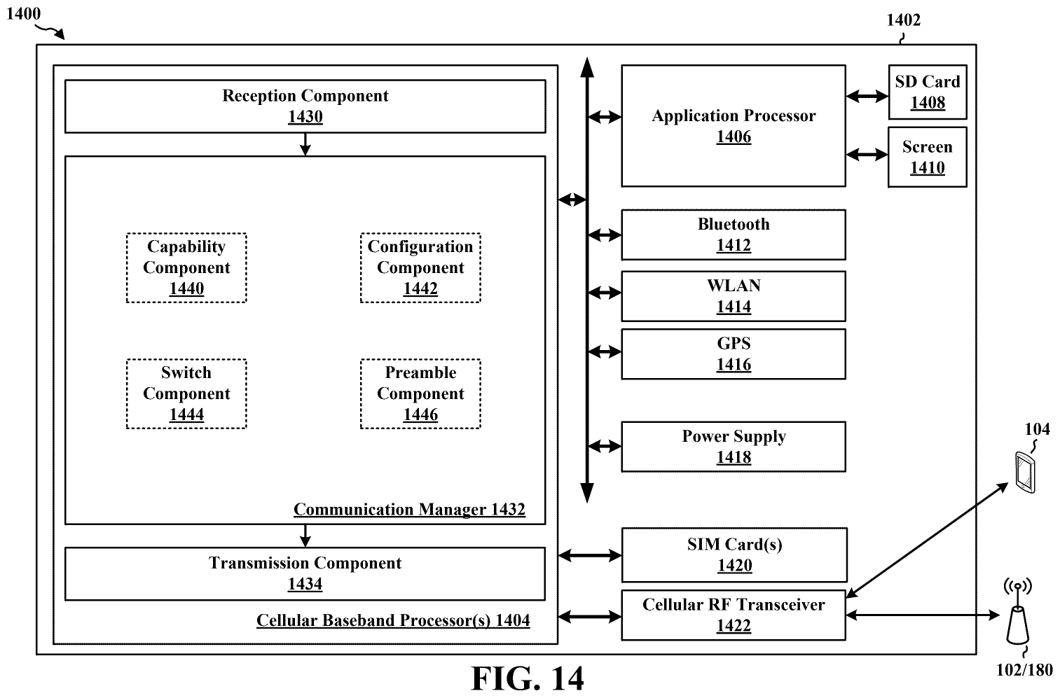

FIG. 14 is a diagram 1400 illustrating an example of a hardware implementation for an apparatus 1402 such as a wireless device according to the various aspects of the present disclosure. In one example, the apparatus 1402 may be a UE such as UE 104, 350, 1204 and includes one or more cellular baseband processors 1404 (also referred to as a modem) coupled to a cellular RF transceiver 1422 and one or more subscriber identity modules (SIM) cards 1420, an application processor 1406 coupled to a secure digital (SD) card 1408 and a screen 1410, a Bluetooth module 1412, a wireless local area network (WLAN) module 1414, a Global Positioning System (GPS) module 1416, and a power supply 1418. The one or more cellular baseband processors 1404 communicate through the cellular RF transceiver 1422 with the BS 102. For example, the cellular RF transceiver 1422 may correspond to or include the transmitters 354TX, receivers 354RX, and antennas 352 of UE 350. In another example, the apparatus 1402 may be a base station such as base station 102/180 or one or more components of disaggregated base station 181, in which case the one or more cellular baseband processors 1404 may be replaced by baseband unit(s) (not shown), and in which case one or more illustrated components of FIG. 14 coupled to the baseband unit(s) may be omitted. In such case, the cellular RF transceiver 1422 may correspond to or include the transmitters 318TX, receivers 318RX, and antennas 320 of base station 310.

The one or more cellular baseband processors 1404 or baseband units may each include a computer-readable medium/one or more memories. The computer-readable medium/one or more memories may be non-transitory. The one or more cellular baseband processors 1404 or baseband units are responsible for general processing, including the execution of software stored on the computer-readable medium/one or more memories individually or in combination. The software, when executed by the one or more cellular baseband processors 1404 or baseband units, causes the one or more cellular baseband processors 1404 or baseband units to, individually or in combination, perform the various functions described supra. The computer-readable medium/one or more memories may also be used individually or in combination for storing data that is manipulated by the one or more cellular baseband processors 1404 or baseband units when executing software. The one or more cellular baseband processors 1404 or baseband units individually or in combination further include a reception component 1430, a communication manager 1432, and a transmission component 1434. The communication manager 1432 includes the one or more illustrated components. The components within the communication manager 1432 may be stored in the computer-readable medium/one or more memories and/or configured as hardware within the one or more cellular baseband processors 1404 or baseband units. The one or more cellular baseband processors 1404 or baseband units may be components of the UE 104, 350, 1204, base station 102/180, 310, 1202, or disaggregated base station 181, and may individually or in combination include the one or more memories 360, 376 and/or at least one of the one or more TX processors 316, 368, at least one of the one or more RX processors 356, 370 and at least one of the one or more controllers/processors 359, 375. For example, the computer-readable medium/one or more memories may correspond to or include the one or more memories 360, 376, the reception component 1430 may correspond to or include the one or more RX processors 356, 370, the communication manager 1432 may correspond to or include the one or more controllers/processors 359, 375, and the transmission component 1434 may correspond to or include the one or more TX processors 316, 368. In one configuration, the apparatus 1402 may be a modem chip and include just the one or more baseband processors 1404, and in another configuration, the apparatus 1402 may be the entire UE (e.g., UE 350 of FIG. 3) and include the aforediscussed additional modules of the apparatus 1402. In a further configuration, the apparatus 1402 may include just the baseband units, and in another configuration, the apparatus 1402 may be the entire base station (e.g., base station 310 of FIG. 3) and include the aforediscussed additional modules of the apparatus 1402.

The communication manager 1432 may include a capability component 1440 that is configured to transmit to a network entity, or receive from a UE, a capability indication of one of an SBFD configuration or a non-SBFD configuration for association with a RACH occasion, such as described in connection with block 1302 of FIG. 13A. In one configuration, the capability component 1440 may be configured to transmit to a network entity, or receive from a UE, an indication of one or more supported configurations among a a SBFD configuration and a non-SBFD configuration, such as described in connection with block 1306 of FIG. 13A. In one configuration, the capability component 1440 may be configured to transmit or receive, based on the RACH occasion being a valid RACH occasion for a RACH preamble transmission, an indication of a UE capability for switching from a first uplink configuration associated with SBFD communications to a second uplink configuration associated with non-SBFD communications, the indication including a selection of a configuration transition period from one of: a first time period including a quantity of guard symbols prior to the beginning of the RACH occasion, a second time period including the quantity of guard symbols following the end of the RACH occasion, or a third time period within a transition period between an SBFD symbol and a subsequent non-SBFD symbol, such as described in connection with block 1310 of FIG. 13A. In one configuration, the capability component 1440 may be configured to report a first transmission time capability indicating a transition time between downlink reception and uplink SBFD transmission in one or more slots including an SBFD symbol, such as described in connection with block 1312 of FIG. 13A. In one configuration, the capability component 1440 may be configured to report a second transmission time capability indicating a configuration transition period for switching between the uplink SBFD transmission and an uplink non-SBFD transmission, such as described in connection with block 1314 of FIG. 13A.

The communication manager 1432 may further include a configuration component 1442 that is configured to receive from a network entity, or transmit to a UE, an RRC configuration that indicates one of an SBFD configuration or a non-SBFD configuration associated with a RACH occasion, such as described in connection with block 1304 of FIG. 13A. In one configuration, the configuration component 1442 may be configured to receive from the network entity, or transmit to the UE, information that indicates one of the SBFD configuration or the non-SBFD configuration selected from the one or more supported configurations for association with a RACH occasion, such as described in connection with block 1308 of FIG. 13A. In one configuration, the configuration component 1442 may be configured to receive or transmit a configuration of the RACH occasion spanning across: at least a portion of a SBFD symbol, at least a portion of a subsequent non-SBFD symbol in a same slot as or a different slot than the SBFD symbol, and a transition period between the SBFD symbol and the subsequent non-SBFD symbol, the transition period being for transitioning between SBFD communications and non-SBFD communications, such as described in connection with block 1316 of FIG. 13B.

The communication manager 1432 may further include a switch component 1444 that is configured to perform a UE switch, refrain from performing a UE switch, or determine whether a UE is to perform a UE switch or refrained UE switch, from a first uplink configuration associated with the SBFD communications to a second uplink configuration associated with the non-SBFD communications during the configuration transition period, the configuration transition period including one of: the first time period prior to a beginning of the RACH occasion in the SBFD symbol, the second time period following an end of the RACH occasion in the subsequent non-SBFD symbol, or the third time period within the transition period between the SBFD symbol and the subsequent non-SBFD symbol, such as described in connection with block 1318 of FIG. 13B. In one configuration, the switch component 1444 may be configured to switch to the second uplink configuration during the first time period, the first time period being specific to the UE, such as described in connection with block 1320 of FIG. 13B. In one configuration, the switch component 1444 may be configured to switch to the second uplink configuration during the second time period, such as described in connection with block 1322 of FIG. 13B. In one configuration, the switch component 1444 may be configured to switch to the second uplink configuration during the third time period, such as described in connection with block 1324 of FIG. 13B. In one configuration, the switch component 1444 may be configured to refrain from switching to the second uplink configuration based on a value of a quantity of the guard symbols, such as described in connection with block 1326 of FIG. 13B.

The communication manager 1432 may further include a preamble component 1446 that is configured to transmit to a network entity or receive from a UE, in the RACH occasion, a RACH preamble in the SBFD symbol and the subsequent non-SBFD symbol before, during, or after the UE switch or the refrained UE switch determined or performed at the switch component 1444, such as further described in connection with block 1318 of FIG. 13B.

The apparatus may include additional components that perform each of the blocks of the algorithm in the aforementioned flowchart of FIGS. 13A-13B. As such, each block in the aforementioned flowchart of FIGS. 13A-13B may be performed by a component and the apparatus may include one or more of those components. The components may be one or more hardware components specifically configured to carry out the stated processes/algorithm, implemented by one or more processors individually or in combination configured to perform the stated processes/algorithm, stored within a computer-readable medium for implementation by one or more processors, or some combination thereof.

In one configuration, the apparatus 1402, and in particular the one or more cellular baseband processors 1404 or baseband units, includes means for receiving or means for transmitting a configuration of a RACH occasion spanning across: at least a portion of a SBFD symbol, at least a portion of a subsequent non-SBFD symbol in a same slot as or a different slot than the SBFD symbol, and a transition period between the SBFD symbol and the subsequent non-SBFD symbol, the transition period being for transitioning between SBFD communications and non-SBFD communications without interruption of a RACH preamble transmission; wherein the means for receiving or means for transmitting is further configured to transmit or receive, in the RACH occasion, a RACH preamble in the SBFD symbol and the subsequent non-SBFD symbol before, during, or after a UE switch or a refrained UE switch from a first uplink configuration associated with the SBFD communications to a second uplink configuration associated with the non-SBFD communications during a configuration transition period, the configuration transition period including one of: a first time period prior to a beginning of the RACH occasion in the SBFD symbol, a second time period following an end of the RACH occasion in the subsequent non-SBFD symbol, or a third time period within the transition period between the SBFD symbol and the subsequent non-SBFD symbol.

In one configuration, the apparatus 1402, and in particular the one or more cellular baseband processors 1404 or baseband units, includes means for switching to the second uplink configuration during the first time period, the first time period being specific to the apparatus. In one configuration, the apparatus 1402, and in particular the one or more cellular baseband processors 1404 or baseband units, includes means for switching to the second uplink configuration during the second time period. In one configuration, the apparatus 1402, and in particular the one or more cellular baseband processors 1404 or baseband units, includes means for switching to the second uplink configuration during the third time period.

In one configuration, the apparatus 1402, and in particular the one or more cellular baseband processors 1404 or baseband units, includes means for transmitting to a network entity, or means for receiving from a UE, a capability indication of the one of the SBFD configuration or the non-SBFD configuration, the configuration of the RACH occasion being based on the capability indication. In one configuration, the apparatus 1402, and in particular the one or more cellular baseband processors 1404 or baseband units, includes means for receiving from a network entity, or means for transmitting to a UE, a RRC configuration that indicates the one of the SBFD configuration or the non-SBFD configuration associated with the RACH occasion. In one configuration, the apparatus 1402, and in particular the one or more cellular baseband processors 1404 or baseband units, includes means for transmitting to a network entity, or means for receiving from a UE, an indication of one or more supported configurations among the SBFD configuration and the non-SBFD configuration; and means for receiving from the network entity, or means for transmitting to the UE, information that indicates the one of the SBFD configuration or the non-SBFD configuration selected from the one or more supported configurations for association with the RACH occasion.

In one configuration, the apparatus 1402, and in particular the one or more cellular baseband processors 1404 or baseband units, includes means for transmitting or means for receiving, based on the RACH occasion being a valid RACH occasion for the RACH preamble transmission, an indication of a UE capability for switching from the first uplink configuration to the second uplink configuration, the indication including: a selection of the configuration transition period from one of: the first time period including a quantity of guard symbols prior to the beginning of the RACH occasion, the second time period including the quantity of guard symbols following the end of the RACH occasion, or the third time period within the transition period between the SBFD symbol and the subsequent non-SBFD symbol.

In one configuration, the apparatus 1402, and in particular the one or more cellular baseband processors 1404 or baseband units, includes means for reporting a first transmission time capability indicating a transition time between downlink reception and uplink SBFD transmission in one or more slots including the SBFD symbol; and means for reporting a second transmission time capability indicating the configuration transition period for switching between the uplink SBFD transmission and an uplink non-SBFD transmission.

The aforementioned means may be one or more of the aforementioned components of the apparatus 1402 configured to perform the functions recited by the aforementioned means. Moreover, as described supra, the apparatus 1402 may include the one or more TX processors 316, 368, the one or more RX processors 356, 370, and the one or more controllers/processors 359, 375. As such, in one configuration, the aforementioned means may be at least one of the one or more TX processors 316, 368, at least one of the one or more RX processors 356, 370, or at least one of the one or more controllers/processors 359, 375, individually or in any combination configured to perform the functions recited by the aforementioned means.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein but is to be accorded the full scope consistent with the language claims, wherein reference to an element in the singular is not intended to mean “one and only one” unless specifically so stated, but rather “one or more.” Terms such as “if,” “when,” and “while” should be interpreted to mean “under the condition that” rather than imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

As used herein, a processor, at least one processor, and/or one or more processors, individually or in combination, configured to perform or operable for performing a plurality of actions (such as the functions described supra) is meant to include at least two different processors able to perform different, overlapping or non-overlapping subsets of the plurality actions, or a single processor able to perform all of the plurality of actions. In one non-limiting example of multiple processors being able to perform different ones of the plurality of actions in combination, a description of a processor, at least one processor, and/or one or more processors configured or operable to perform actions X, Y, and Z may include at least a first processor configured or operable to perform a first subset of X, Y, and Z (e.g., to perform X) and at least a second processor configured or operable to perform a second subset of X, Y, and Z (e.g., to perform Y and Z). Alternatively, a first processor, a second processor, and a third processor may be respectively configured or operable to perform a respective one of actions X, Y, and Z. It should be understood that any combination of one or more processors each may be configured or operable to perform any one or any combination of a plurality of actions.

Similarly as used herein, a memory, at least one memory, a computer-readable medium, and/or one or more memories, individually or in combination, configured to store or having stored thereon instructions executable by one or more processors for performing a plurality of actions (such as the functions described supra) is meant to include at least two different memories able to store different, overlapping or non-overlapping subsets of the instructions for performing different, overlapping or non-overlapping subsets of the plurality actions, or a single memory able to store the instructions for performing all of the plurality of actions. In one non-limiting example of one or more memories, individually or in combination, being able to store different subsets of the instructions for performing different ones of the plurality of actions, a description of a memory, at least one memory, a computer-readable medium, and/or one or more memories configured or operable to store or having stored thereon instructions for performing actions X, Y, and Z may include at least a first memory configured or operable to store or having stored thereon a first subset of instructions for performing a first subset of X, Y, and Z (e.g., instructions to perform X) and at least a second memory configured or operable to store or having stored thereon a second subset of instructions for performing a second subset of X, Y, and Z (e.g., instructions to perform Y and Z). Alternatively, a first memory, a second memory, and a third memory may be respectively configured to store or have stored thereon a respective one of a first subset of instructions for performing X, a second subset of instruction for performing Y, and a third subset of instructions for performing Z. It should be understood that any combination of one or more memories each may be configured or operable to store or have stored thereon any one or any combination of instructions executable by one or more processors to perform any one or any combination of a plurality of actions. Moreover, one or more processors may each be coupled to at least one of the one or more memories and configured or operable to execute the instructions to perform the plurality of actions. For instance, in the above non-limiting example of the different subset of instructions for performing actions X, Y, and Z, a first processor may be coupled to a first memory storing instructions for performing action X, and at least a second processor may be coupled to at least a second memory storing instructions for performing actions Y and Z, and the first processor and the second processor may, in combination, execute the respective subset of instructions to accomplish performing actions X, Y, and Z. Alternatively, three processors may access one of three different memories each storing one of instructions for performing X, Y, or Z, and the three processors may in combination execute the respective subset of instruction to accomplish performing actions X, Y, and Z. Alternatively, a single processor may execute the instructions stored on a single memory, or distributed across multiple memories, to accomplish performing actions X, Y, and Z.

The following examples are illustrative only and may be combined with aspects of other embodiments or teachings described herein, without limitation.
Clause 1. An apparatus for wireless communication, comprising: one or more memories; and one or more processors each communicatively coupled with at least one of the one or more memories, the one or more processors, individually or in any combination, operable to cause the apparatus to: receive or transmit a configuration of a random access channel (RACH) occasion spanning across: at least a portion of a sub-band frequency division duplex (SBFD) symbol, at least a portion of a subsequent non-SBFD symbol in a same slot as or a different slot than the SBFD symbol, and a transition period between the SBFD symbol and the subsequent non-SBFD symbol, the transition period being for transitioning between SBFD communications and non-SBFD communications without interruption of a RACH preamble transmission; and transmit or receive, in the RACH occasion, a RACH preamble in the SBFD symbol and the subsequent non-SBFD symbol before, during, or after a UE switch or a refrained UE switch from a first uplink configuration associated with the SBFD communications to a second uplink configuration associated with the non-SBFD communications during a configuration transition period, the configuration transition period including one of: a first time period prior to a beginning of the RACH occasion in the SBFD symbol, a second time period following an end of the RACH occasion in the subsequent non-SBFD symbol, or a third time period within the transition period between the SBFD symbol and the subsequent non-SBFD symbol.
Clause 2. The apparatus of clause 1, wherein the one or more processors, individually or in any combination, are further operable to cause the apparatus to: switch to the second uplink configuration during the first time period, the first time period being specific to the apparatus.
Clause 3. The apparatus of clause 1 or clause 2, wherein the RACH occasion is a valid RACH occasion for the RACH preamble transmission based on a presence of at least a guard period between a last symbol including downlink data and an initial symbol of the RACH occasion.
Clause 4. The apparatus of clause 1, wherein the one or more processors, individually or in any combination, are further operable to cause the apparatus to: switch to the second uplink configuration during the second time period.
Clause 5. The apparatus of clause 1, wherein the one or more processors, individually or in any combination, are further operable to cause the apparatus to: switch to the second uplink configuration during the third time period.
Clause 6. The apparatus of any of clauses 1 to 5, wherein the UE switch to the second uplink configuration is responsive to a scheduling restriction for at least one of downlink data or uplink data during a quantity of guard symbols in at least one of: the first time period based on a non-SBFD transmission capability of the apparatus for the RACH preamble transmission, or the second time period based on a SBFD transmission capability of the apparatus for the RACH preamble transmission.
Clause 7. The apparatus of any of clauses 1 to 6, wherein the configuration of the RACH occasion includes one of an SBFD configuration or a non-SBFD configuration.
Clause 8. The apparatus of clause 7, wherein the one or more processors, individually or in any combination, are further operable to cause the apparatus to: transmit to a network entity, or receive from a user equipment (UE), a capability indication of the one of the SBFD configuration or the non-SBFD configuration, the configuration of the RACH occasion being based on the capability indication.
Clause 9. The apparatus of clause 7, wherein the one or more processors, individually or in any combination, are further operable to cause the apparatus to: receive from a network entity, or transmit to a user equipment (UE), a radio resource control (RRC) configuration that indicates the one of the SBFD configuration or the non-SBFD configuration associated with the RACH occasion.
Clause 10. The apparatus of clause 7, wherein the one or more processors, individually or in any combination, are further operable to cause the apparatus to: transmit to a network entity, or receive from a user equipment (UE), an indication of one or more supported configurations among the SBFD configuration and the non-SBFD configuration; and receive from the network entity, or transmit to the UE, information that indicates the one of the SBFD configuration or the non-SBFD configuration selected from the one or more supported configurations for association with the RACH occasion.
Clause 11. The apparatus of any of clauses 1 to 10, wherein the one or more processors, individually or in any combination, are further operable to cause the apparatus to: transmit or receive, based on the RACH occasion being a valid RACH occasion for the RACH preamble transmission, an indication of a user equipment (UE) capability for switching from the first uplink configuration to the second uplink configuration, the indication including: a selection of the configuration transition period from one of: the first time period including a quantity of guard symbols prior to the beginning of the RACH occasion, the second time period including the quantity of guard symbols following the end of the RACH occasion, or the third time period within the transition period between the SBFD symbol and the subsequent non-SBFD symbol.
Clause 12. The apparatus of clause 11, wherein the indication further includes the quantity of the guard symbols for one or more subcarrier spacings (SCS), and the one or more processors, individually or in any combination, are further operable to cause the apparatus to: refrain from switching to the second uplink configuration based on a value of the quantity of the guard symbols.
Clause 13. The apparatus of any of clauses 1 to 12, wherein the one or more processors, individually or in any combination, are further operable to cause the apparatus to: report a first transmission time capability indicating a transition time between downlink reception and uplink SBFD transmission in one or more slots including the SBFD symbol; and report a second transmission time capability indicating the configuration transition period for switching between the uplink SBFD transmission and an uplink non-SBFD transmission.
Clause 14. The apparatus of any of clauses 1 to 13, wherein the RACH occasion is associated with an SBFD transmission configuration, and the RACH occasion is a valid RACH occasion for the RACH preamble transmission based on a presence of: a first guard period between a last symbol including downlink data and an initial symbol of the RACH occasion, the first guard period having a duration of at least a transition time between downlink reception and uplink SBFD transmission in one or more slots including the SBFD symbol, and a second guard period between a last symbol of the RACH occasion and an initial symbol including uplink data, the second guard period having a duration of at least the configuration transition period for switching between the uplink SBFD transmission and an uplink non-SBFD transmission.
Clause 15. The apparatus of any of clauses 1 to 13, wherein the RACH occasion is associated with an SBFD transmission configuration, and the RACH occasion is a valid RACH occasion for the RACH preamble transmission based on a presence of a guard period between a last symbol of the RACH occasion and an initial symbol including uplink data, the guard period having a duration of at least the configuration transition period for switching between an uplink SBFD transmission and an uplink non-SBFD transmission.
Clause 16. The apparatus of any of clauses 1 to 13, wherein the RACH occasion is associated with a non-SBFD transmission configuration, and the RACH occasion is a valid RACH occasion for the RACH preamble transmission based on a presence of a guard period between a last symbol including downlink data and an initial symbol of the RACH occasion, the guard period having a duration of one of: at least a combined transition time including: a transition time between downlink SBFD reception and uplink SBFD transmission in one or more slots including the SBFD symbol, and the configuration transition period for switching between the uplink SBFD transmission and an uplink non-SBFD transmission, or at least a maximum transition time between the transition time and the configuration transition period.
Clause 17. The apparatus of any of clauses 1 to 13, wherein the RACH occasion is associated with a non-SBFD transmission configuration, and the RACH occasion is a valid RACH occasion for the RACH preamble transmission based on a presence of a guard period between a last symbol including uplink data and an initial symbol of the RACH occasion, the guard period having a duration of at least the configuration transition period for switching between an uplink SBFD transmission and an uplink non-SBFD transmission.
Clause 18. A method of wireless communication performable at a wireless device, comprising: receiving or transmitting a configuration of a random access channel (RACH) occasion spanning across: at least a portion of a sub-band frequency division duplex (SBFD) symbol, at least a portion of a subsequent non-SBFD symbol in a same slot as or a different slot than the SBFD symbol, and a transition period between the SBFD symbol and the subsequent non-SBFD symbol, the transition period being for transitioning between SBFD communications and non-SBFD communications without interruption of a RACH preamble transmission; and transmitting or receiving, in the RACH occasion, a RACH preamble in the SBFD symbol and the subsequent non-SBFD symbol before, during, or after a UE switch or a refrained UE switch from a first uplink configuration associated with the SBFD communications to a second uplink configuration associated with the non-SBFD communications during a configuration transition period, the configuration transition period including one of: a first time period prior to a beginning of the RACH occasion in the SBFD symbol, a second time period following an end of the RACH occasion in the subsequent non-SBFD symbol, or a third time period within the transition period between the SBFD symbol and the subsequent non-SBFD symbol.
Clause 19. The method of clause 18, further comprising: switching to the second uplink configuration during the first time period, the second time period, or the third time period.
Clause 20. An apparatus for wireless communication, comprising: means for receiving or transmitting a configuration of a random access channel (RACH) occasion spanning across: at least a portion of a sub-band frequency division duplex (SBFD) symbol, at least a portion of a subsequent non-SBFD symbol in a same slot as or a different slot than the SBFD symbol, and a transition period between the SBFD symbol and the subsequent non-SBFD symbol, the transition period being for transitioning between SBFD communications and non-SBFD communications without interruption of a RACH preamble transmission; and wherein the means for receiving or transmitting is further configured to transmit or receive, in the RACH occasion, a RACH preamble in the SBFD symbol and the subsequent non-SBFD symbol before, during, or after a UE switch or a refrained UE switch from a first uplink configuration associated with the SBFD communications to a second uplink configuration associated with the non-SBFD communications during a configuration transition period, the configuration transition period including one of: a first time period prior to a beginning of the RACH occasion in the SBFD symbol, a second time period following an end of the RACH occasion in the subsequent non-SBFD symbol, or a third time period within the transition period between the SBFD symbol and the subsequent non-SBFD symbol.

What is claimed is:

1. An apparatus for wireless communication, comprising:
one or more memories; and
one or more processors each communicatively coupled with at least one of the one or more memories, the one or more processors, individually or in any combination, operable to cause the apparatus to:
receive or transmit a configuration of a random access channel (RACH) occasion spanning across:
at least a portion of a sub-band frequency division duplex (SBFD) symbol,
at least a portion of a subsequent non-SBFD symbol in a same slot as or a different slot than the SBFD symbol, and
a transition period between the SBFD symbol and the subsequent non-SBFD symbol, the transition period being for transitioning between SBFD communications and non-SBFD communications without interruption of a RACH preamble transmission; and
transmit or receive, in the RACH occasion, a RACH preamble in the SBFD symbol and the subsequent non-SBFD symbol before, during, or after a user equipment (UE) switch or a refrained UE switch from a first uplink configuration associated with the SBFD communications to a second uplink configuration associated with the non-SBFD communications during a configuration transition period, the configuration transition period including one of:
a first time period prior to a beginning of the RACH occasion in the SBFD symbol,
a second time period following an end of the RACH occasion in the subsequent non-SBFD symbol, or
a third time period within the transition period between the SBFD symbol and the subsequent non-SBFD symbol.

2. The apparatus of claim 1, wherein the one or more processors, individually or in any combination, are further operable to cause the apparatus to:
switch to the second uplink configuration during the first time period, the first time period being specific to the apparatus.

3. The apparatus of claim 1, wherein the RACH occasion is a valid RACH occasion for transmission of the RACH preamble based on a presence of at least a guard period between a last symbol including downlink data and an initial symbol of the RACH occasion.

4. The apparatus of claim 1, wherein the one or more processors, individually or in any combination, are further operable to cause the apparatus to:
switch to the second uplink configuration during the second time period.

5. The apparatus of claim 1, wherein the one or more processors, individually or in any combination, are further operable to cause the apparatus to:
switch to the second uplink configuration during the third time period.

6. The apparatus of claim 1, wherein the UE switch to the second uplink configuration is responsive to a scheduling restriction for at least one of downlink data or uplink data during a quantity of guard symbols in at least one of:
the first time period based on a non-SBFD transmission capability of the apparatus for transmission of the RACH preamble, or
the second time period based on a SBFD transmission capability of the apparatus for transmission of the RACH preamble.

7. The apparatus of claim 1, wherein the configuration of the RACH occasion includes one of an SBFD configuration or a non-SBFD configuration.

8. The apparatus of claim 7, wherein the one or more processors, individually or in any combination, are further operable to cause the apparatus to:
transmit to a network entity, or receive from a user equipment (UE), a capability indication of the one of the SBFD configuration or the non-SBFD configuration, the configuration of the RACH occasion being based on the capability indication.

9. The apparatus of claim 7, wherein the one or more processors, individually or in any combination, are further operable to cause the apparatus to:
receive from a network entity, or transmit to a user equipment (UE), a radio resource control (RRC) configuration that indicates the one of the SBFD configuration or the non-SBFD configuration associated with the RACH occasion.

10. The apparatus of claim 7, wherein the one or more processors, individually or in any combination, are further operable to cause the apparatus to:
transmit to a network entity, or receive from a user equipment (UE), an indication of one or more supported configurations among the SBFD configuration and the non-SBFD configuration; and
receive from the network entity, or transmit to the UE, information that indicates the one of the SBFD configuration or the non-SBFD configuration selected from the one or more supported configurations for association with the RACH occasion.

11. The apparatus of claim 1, wherein the one or more processors, individually or in any combination, are further operable to cause the apparatus to:
transmit or receive, based on the RACH occasion being a valid RACH occasion for transmission of the RACH preamble, an indication of a user equipment (UE) capability for switching from the first uplink configuration to the second uplink configuration, the indication including:
a selection of the configuration transition period from one of:
the first time period including a quantity of guard symbols prior to the beginning of the RACH occasion,
the second time period including the quantity of guard symbols following the end of the RACH occasion, or
the third time period within the transition period between the SBFD symbol and the subsequent non-SBFD symbol.

12. The apparatus of claim 11, wherein the indication further includes the quantity of the guard symbols for one or more subcarrier spacings (SCS), and the one or more processors, individually or in any combination, are further operable to cause the apparatus to:
refrain from switching to the second uplink configuration based on a value of the quantity of the guard symbols.

13. The apparatus of claim 1, wherein the one or more processors, individually or in any combination, are further operable to cause the apparatus to:
report a first transmission time capability indicating a transition time between downlink reception and uplink SBFD transmission in one or more slots including the SBFD symbol; and
report a second transmission time capability indicating the configuration transition period for switching between the uplink SBFD transmission and an uplink non-SBFD transmission.

14. The apparatus of claim 1, wherein the RACH occasion is associated with an SBFD transmission configuration, and the RACH occasion is a valid RACH occasion for transmission of the RACH preamble based on a presence of:
a first guard period between a last symbol including downlink data and an initial symbol of the RACH occasion, the first guard period having a duration of at least a transition time between downlink reception and uplink SBFD transmission in one or more slots including the SBFD symbol, and
a second guard period between a last symbol of the RACH occasion and an initial symbol including uplink data, the second guard period having a duration of at least the configuration transition period for switching between the uplink SBFD transmission and an uplink non-SBFD transmission.

15. The apparatus of claim 1, wherein the RACH occasion is associated with an SBFD transmission configuration, and the RACH occasion is a valid RACH occasion for transmission of the RACH preamble based on a presence of a guard period between a last symbol of the RACH occasion and an initial symbol including uplink data, the guard period having a duration of at least the configuration transition period for switching between an uplink SBFD transmission and an uplink non-SBFD transmission.

16. The apparatus of claim 1, wherein the RACH occasion is associated with a non-SBFD transmission configuration, and the RACH occasion is a valid RACH occasion for transmission of the RACH preamble based on a presence of a guard period between a last symbol including downlink data and an initial symbol of the RACH occasion, the guard period having a duration of one of:
at least a combined transition time including:
a transition time between downlink SBFD reception and uplink SBFD transmission in one or more slots including the SBFD symbol, and
the configuration transition period for switching between the uplink SBFD transmission and an uplink non-SBFD transmission, or
at least a maximum transition time between the transition time and the configuration transition period.

17. The apparatus of claim 1, wherein the RACH occasion is associated with a non-SBFD transmission configuration, and the RACH occasion is a valid RACH occasion for transmission of the RACH preamble based on a presence of a guard period between a last symbol including uplink data and an initial symbol of the RACH occasion, the guard period having a duration of at least the configuration transition period for switching between an uplink SBFD transmission and an uplink non-SBFD transmission.

18. A method of wireless communication performable at a wireless device, comprising:
receiving or transmitting a configuration of a random access channel (RACH) occasion spanning across:
at least a portion of a sub-band frequency division duplex (SBFD) symbol,
at least a portion of a subsequent non-SBFD symbol in a same slot as or a different slot than the SBFD symbol, and
a transition period between the SBFD symbol and the subsequent non-SBFD symbol, the transition period being for transitioning between SBFD communications and non-SBFD communications without interruption of a RACH preamble transmission; and
transmitting or receiving, in the RACH occasion, a RACH preamble in the SBFD symbol and the subsequent non-SBFD symbol before, during, or after a user equipment (UE) switch or a refrained UE switch from a first uplink configuration associated with the SBFD communications to a second uplink configuration associated with the non-SBFD communications during a configuration transition period, the configuration transition period including one of:
a first time period prior to a beginning of the RACH occasion in the SBFD symbol,
a second time period following an end of the RACH occasion in the subsequent non-SBFD symbol, or
a third time period within the transition period between the SBFD symbol and the subsequent non-SBFD symbol.

19. The method of claim 18, further comprising:
switching to the second uplink configuration during the first time period, the second time period, or the third time period.

20. An apparatus for wireless communication, comprising:
means for receiving or transmitting a configuration of a random access channel (RACH) occasion spanning across:
at least a portion of a sub-band frequency division duplex (SBFD) symbol,
at least a portion of a subsequent non-SBFD symbol in a same slot as or a different slot than the SBFD symbol, and
a transition period between the SBFD symbol and the subsequent non-SBFD symbol, the transition period being for transitioning between SBFD communications and non-SBFD communications without interruption of a RACH preamble transmission; and
wherein the means for receiving or transmitting is further configured to transmit or receive, in the RACH occasion, a RACH preamble in the SBFD symbol and the subsequent non-SBFD symbol before, during, or after a user equipment (UE) switch or a refrained UE switch from a first uplink configuration associated with the SBFD communications to a second uplink configuration associated with the non-SBFD communications during a configuration transition period, the configuration transition period including one of:
a first time period prior to a beginning of the RACH occasion in the SBFD symbol,
a second time period following an end of the RACH occasion in the subsequent non-SBFD symbol, or
a third time period within the transition period between the SBFD symbol and the subsequent non-SBFD symbol.
